(19) United States
(12) Patent Application Publication
(10) Pub. No.: US 2018/0099756 A1
(43) Pub. Date: Apr. 12, 2018

(54) Aircraft Battery Systems and Aircraft Including Same

(71) Applicant: Impossible Aerospace Corporation, Sunnyvale, CA (US)

(72) Inventor: Albert Spencer Gore, Santa Clara, CA (US)

(21) Appl. No.: 15/713,539

(22) Filed: Sep. 22, 2017

Related U.S. Application Data
(60) Provisional application No. 62/399,431, filed on Sep. 25, 2016.
(60) Provisional application No. 62/399,470, filed on Sep. 25, 2016.
(60) Provisional application No. 62/469,201, filed on Mar. 9, 2017.
(60) Provisional application No. 62/469,262, filed on Mar. 9, 2017.
(60) Provisional application No. 62/469,324, filed on Mar. 9, 2017.

(51) Int. Cl. B64D 27/24; H01M 10/0525; H01M 10/058

(52) U.S. Cl. CPC B64D 27/24; H01M 10/058; H01M 10/0525

(57) ABSTRACT

Battery modules for unmanned and human piloted electric aircraft comprise two planar substrates with electrochemical cells secured between to form load-bearing structural components from which aircraft with greater endurance can be constructed. The cells can be oriented perpendicular or parallel to the substrates, and in the latter case the substrates can include slots that the cells fit into. The cells can be secured to the substrates by adhesives, welding, soldering and the like, as well as by mechanical tensioners. Battery modules can be formed to the shapes of aircraft parts such as wings. Multirotor aircraft are disclosed in which the arms and other parts of the aircraft are constructed from such battery modules.

### CROSS-REFERENCE TO RELATED APPLICATIONS

This application claims priority to U.S. provisional patent application No. 62/399,431 filed on Sep. 25, 2016 and entitled “Aircraft Energy Storage System,” and priority to U.S. provisional patent application No. 62/399,470 filed on Sep. 25, 2016 and entitled “Multirotor Aircraft,” and priority to U.S. provisional patent application No. 62/469,201 filed on Mar. 9, 2017 and entitled “Multirotor Aircraft Battery Architecture,” and priority to U.S. provisional patent application No. 62/469,262 filed on Mar. 9, 2017 and entitled “Structural and Profiled Battery for Electric Aircraft and Drones,” and priority to U.S. provisional patent application No. 62/469,324 filed on Mar. 9, 2017 and entitled “Structural Battery for Electric Aircraft and UAVs,” all five of which are incorporated herein by reference in their entireties. This application is related to US patent application Ser. No. ______ filed on even date herewith (atty. Docket no. 6582.02/8161.002) and also titled “Aircraft Battery Systems and Aircraft including Same.”

### BACKGROUND

### Field of the Invention

The invention is in the field of electric aircraft and directed more particularly to load-bearing composite structures including battery modules that make these aircraft both lighter and able to store greater amounts of energy for greater endurance.

### Related Art

Presently, electric-powered aircraft exist for both human transportation as well as the more familiar unmanned aircraft systems (UASs), sometimes also called unmanned aerial vehicles (UAVs) or just “drones,” that will be referred to herein collectively as electric aircraft. Electric aircraft, like aircraft that combust fuel for power, are limited by how much energy they can carry and by their own weight. Electric aircraft designs thus seek to minimize aircraft weight and maximize the stored energy content of the power supply, typically a collection of batteries. Improving the stored energy content to mass ratio for an aircraft measured in Wh/kg (sometimes referred to as a specific energy) will allow the aircraft to either carry a greater payload, remain in the air longer, traverse a greater distance, or some combination of these.

One class of UAV is the multirotor aircraft. Present commercial multirotor aircraft (quadcoptors having four rotors being a common example) achieve hover endurances on the order of 20-30 minutes. These endurances are limited due to a combination of the high-power requirements of these vehicles and a relatively low cell mass/total vehicle mass ratio in part due to the low energy density of required high-power battery cells. All applications of electric aircraft are improved by increasing the aircraft specific energy which enables lower discharge rates for the cells, which generally improves cell longevity.

Today's multirotor aircraft generally share a common design: three or more rotors, each powered by its own electric motor, placed some distance away from the vehicle's center of mass, all powered by a central energy storage system (usually a lithium-ion polymer type battery), at or near the center of mass. Some alternate designs, however, locate separate batteries in nacelles beneath the motor/rotor pairs. Housings or beams, generally made of plastic or composites, carry structural loads between each rotor and the central hub, which can include a payload and/or the energy storage system. Wires or printed circuit boards (PCBs) are typically used to carry current from the central energy storage system to the several motors.

Battery packs for electric vehicles have become commonplace among major automakers, and a number of patents have been filed that use batteries packs or cells to provide rigidity to existing structures or to provide crash absorption. In other words, in some prior applications the structure of the battery has been used to augment an existing load-bearing structure, but in no instance does the battery structure serve as the sole load-bearing structure.

### SUMMARY

An exemplary battery module of the present invention, for use in an electric aircraft, comprises a first planar substrate, a second planar substrate disposed essentially parallel to the first planar substrate, and a plurality of electrochemical cells secured to and between the first and second planar substrates. In some of these embodiments the first and second planar substrates each define a plane and the cells are arranged with their longitudinal axes parallel to the planes of the planar substrates. In some of these embodiments the first planar substrate includes an array of rectangular slots and the cells engage with the slots. That is, the cells fit lengthwise into the slots, and in some instances protrude through the slots. In further embodiments, the first and second planar substrates each define a plane and the cells are arranged with their longitudinal axes perpendicular to the planes of the planar substrates. In some of these embodiments, the first planar substrate includes apertures and some of the cells are disposed through those apertures, where the apertures are sized to the cross-section of the cells such that a cylindrical cell would engage with a circular aperture.

In various embodiments, the planar substrates comprise PCBs, but other light-weight substrates can be used. Simple battery modules can be assembled from flat and rectangular planar substrates, but battery modules can also be constructed from non-rectangular planar substrates. Battery modules designed to fit within complex volumes can be created from planar substrates with varied shapes, such as an airfoil rib. Planar substrates can be formed to curved surfaces such as that of a fuselage. Planar substrates can also be shaped to have a footprint, or planform, of a multirotor aircraft.

In various embodiments of the exemplary battery module, the first planar substrate comprises a metal layer having isolated sections defined therein by gaps in the metal layer, wherein the first planar substrate includes a number of terminals, each terminal configured for making an electrical connection to one of the plurality of electrochemical cells. For example, the planar substrates can be PCBs with patterned copper layers. The terminals can include, for example, bonding pads defined within a metal layer and next to holes through the PCB. In some of these embodiments, the bonding pad is electrically connected to the metal layer by a fuse. Also, in some embodiments in which the terminals include holes, a cell of the plurality of cells is in electrical contact with the metal layer of the substrate through the hole, such as by a metal ribbon disposed through the hole and electrically connected both to the cell and to the metal layer. In alternative embodiments, the planar substrates can have metal layers on both sides, or on only one side, and/or on embedded layers. The metal layers both conduct current from the cells to motors and other components, but also can communicate monitoring and control signals.

A suitable cell for the exemplary battery module comprises the 18650 format, but other cylindrical and non-cylindrical cells can be employed. In various embodiments, the cells are secured to one or both planar substrates with an adhesive that adheres each cell to the respective substrate. In some of these embodiments, the bottoms of the cans of the cells are adhered flat against a planar substrate, while in other embodiments a longitudinal line along the length of the can is adhered to the planar substrate, or the cell can be inserted through an aperture in the planar substrate and adhered around the circumference defined by the intersection of the two. Likewise, the planar substrate can include rectangular slots into which the cells fit, and the cells can be adhered to the planar substrate along at least the long sides of the rectangles. Conductive adhesives can be used, and welding and soldering can be used in place of adhesives. The topcaps of the cells optionally can also be adhered, soldered, or welded to planar substrates. Where the join is electrically conductive, a join to the topcap can serve as the connection between the metal layer and the cell's positive polarity; a join to the shoulder, side, or bottom of the can may provide the connection between another metal layer and the cell's negative polarity. The electrical connections can also be made in other ways, such as wires or the ribbons already noted.

In further embodiments, the cells are instead secured between the planar substrates by tensioners attached to both planar substrates, where the tensioners span between the two planar substrates to provide a compressive load to the cells. Tensioners can also be used in combination with bonding through adhesives, soldering or welding.

Various embodiments can include one or more discrete components disposed on either or both planar substrates, or on an auxiliary substrate. Discrete components can comprise, for example, sensors, connectors, and integrated circuits (ICs). ICs can include a charge controller or microcontroller, as just two examples.

Other exemplary battery modules of the present invention, for use in electric aircraft, consist of, or consist essentially of a first planar substrate, a second planar substrate disposed essentially parallel to the first planar substrate, and a plurality of electrochemical cells secured to and between the first and second planar substrates.

Still other exemplary battery modules of the present invention comprise, consist of, or consist essentially of a number of essentially parallel planar substrates, and a layer of electrochemical cells secured to and between every two adjacent planar substrates of the number of planar substrates, where the planar substrates include metal layers that provide electrical connections to and between the cells. In various embodiments, the longitudinal axes of the cells in adjacent layers are parallel but not coaxial. In other embodiments, the longitudinal axes of the cells within each layer are parallel to the planes defined by the planar substrates secured on either side thereof; additionally, the cells of each layer comprise a plurality of rows, and the cells in adjacent rows are staggered relative to one another. In some of the latter embodiments, the cells in adjacent layers are staggered relative to one another. In various embodiments, the cells of adjacent layers are electrically connected in series across the planar substrate, of the plurality of planar substrates, disposed therebetween.

In various embodiments of this exemplary battery module, the planar substrates include rectangular slots and the cells engage with the slots. In other embodiments, the planar substrates include apertures sized to receive the cells, and the cells extend through those apertures. In some of these embodiments, the cells are cylindrical and the negative polarity of each cell is connected to a metal layer of a planar substrate of the plurality of planar substrates by an electrical connection made to the metal layer and to the cylindrical side of each cell.

An exemplary electric aircraft of the present invention comprises, consists of, or consists essentially of a load-bearing structure including a number of essentially parallel planar substrates and a layer of electrochemical cells secured to and between every two adjacent planar substrates of the number of planar substrates, where at least one planar substrate of the plurality of substrates includes one or more metal layers that provide electrical connections between the electrochemical cells. For example, the aircraft can be a multirotor aircraft having at least three arms, the number of essentially parallel planar substrates is two planar substrates, and the planar substrates have a footprint of the multirotor aircraft. As used herein “electric aircraft” also includes hybrid electric aircraft. Load-bearing structures can also comprise components of fixed-wing aircraft, such as the fuselage, wings, and tail.

In some of these multirotor aircraft embodiments one, or both, of the two planar substrates includes rectangular slots and the electrochemical cells engage with the slots. In other multirotor aircraft embodiments the electrochemical cells of the layer of cells secured between the two planar substrates are oriented with their longitudinal axes disposed perpendicular to the planes defined by the planar substrates. In various embodiments of the multirotor aircraft, points of equal electric potential on the arms are electrically connected, and in some of these embodiments the aircraft further comprises discrete circuitry for battery management disposed on one of the two planar substrates, where the integrated circuit is configured to provide a battery management system.

An exemplary method of making a battery module comprises providing at least two planar substrates, securing a plurality of cells to and between the at least two planar substrates, and electrically connecting the positive and negative polarities of each cell of the plurality of cells to one or more metal layers on the at least two planar substrates. In some of these embodiments, the step of providing the at least two planar substrates includes patterning metal layers on the at least two planar substrates. The step of providing the at least two planar substrates can also include defining holes in one of the at least two planar substrates. In some of these embodiments the step of securing the plurality of cells to and between the at least two planar substrates includes inserting some of the cells partially through the holes and fastening the inserted cells to the one of the at least two planar substrates. In other embodiments in which holes are defined, the holes are rectangular and the step of securing the plurality of electrochemical cells to and between the at least two planar substrates includes engaging some of the electrochemical cells with the rectangular holes and fastening the engaged electrochemical cells to the one of the at least two planar substrates. In still other embodiments in which holes are defined, the step of electrically connecting the positive and negative polarities of each cell to metal layers on the at least two planar substrates includes, for at least some of the cells, electrically connecting one end of a metal ribbon to the topcap of the cell, passing the other end of the metal ribbon through a hole, and electrically connecting the other end to a metal layer on the one of the at least two planar substrates. Holes can be defined in planar substrates by techniques such as laser machining and waterjet machining, for example.

### BRIEF DESCRIPTION OF DRAWINGS

FIG. 1 is a perspective view of a battery module according to an exemplary embodiment of the present invention.

FIG. 2 is a top view of a portion of a planar substrate of the battery module of FIG. 1.

FIG. 3 is a schematic illustration of an arrangement of electrochemical cells within a battery module, according to an exemplary embodiment of the present invention.

FIG. 4 is a perspective view of a battery module according to another exemplary embodiment of the present invention.

FIG. 5 is a schematic representation of three successive planar substrates having cells secured therebetween, according to various embodiments of the present invention.

FIG. 6 is a schematic representation of four successive planar substrates having cells secured therebetween in a staggered arrangement, according to various embodiments of the present invention.

FIGS. 7 and 8 are perspective views of battery modules constructed according to the arrangements of FIGS. 5 and 6, respectively.

FIG. 9 a perspective view of a battery module according to still another exemplary embodiment of the present invention.

FIG. 10 shows a top view of a battery module according to yet another exemplary embodiment of the present invention. This drawing also serves as a top view of a row of cells of the embodiment of FIG. 9.

FIGS. 11 and 12 are perspective views of two further battery modules according to still additional exemplary embodiments of the present invention.

FIG. 13 is a perspective view of a battery module according to another exemplary embodiment of the present invention.

FIGS. 14 and 15 are side and front views, respectively, of the battery module of FIG. 13.

FIG. 16 is a perspective view of a multirotor aircraft according to exemplary embodiments of the present invention.

FIG. 17 is a side view of the multirotor aircraft of FIG. 16.

FIGS. 18 and 19 are top and bottom views, respectively, of the multirotor aircraft of FIG. 16.

FIGS. 20-22 are circuit schematic representations of cell arrangements for multirotor aircraft according to embodiments of the present invention.

FIG. 23 is a circuit schematic representation of battery protection and fusing between arms of a multirotor aircraft according to embodiments of the present invention.

FIGS. 24-26 are perspective views of cell arrangements for multirotor aircraft having six, four, and three arms, respectively, according to embodiments of the present invention.

FIGS. 27-28 are perspective views of two different battery module arrangements for quadcoptors according to embodiments of the present invention.

### DETAILED DESCRIPTION OF THE INVENTION

The present invention is directed to load-bearing battery modules for electric aircraft. Such modules comprise a composite structure composed of electrochemical cells sandwiched between planar substrates such as PCBs. The present invention is also directed to electric aircraft comprising such load-bearing structures, including both fixed wing and multirotor aircraft, manned and unmanned, for aerial photography and surveillance, surveying, transportation of people and goods, and other purposes. The present invention is also directed to methods of making such load-bearing structures and electric vehicles.

More specifically, these airframe architectures replace load-bearing structural mass, that detracts from the cell mass/total vehicle mass ratio for the aircraft, with a structure that is still load-bearing but which also includes energy-storing mass as a substantial fraction of the load-bearing member. Raising the cell mass/total vehicle mass ratio for the aircraft in this way improves endurance and performance.

Specific examples disclosed herein are directed to multirotor aircraft that achieve greater performance and endurance by using electrochemical cells and planar substrates carrying electrical conductors as primary structural members and cleverly locating them to reduce the need for extra structural mass. As such, the cells are part of the primary load transfer structures (“arms”) connecting the rotors to the central hub.

Specific examples of these composite structures include arrangements in which the cells set with their longitudinal axes perpendicular to the planes of the planar substrates. Other examples have the longitudinal axes of the cells running parallel to the planes of the planar substrates. In some of these embodiments, rectangular slots cut into the planar substrates are sized to allow the cells to sit down into the substrates, in some instances partially protruding through those substrates. In both arrangements, the cells are secured to the planar substrates by adhesives, soldering, welds, and/or other mechanical means, while metal layers on the planar substrates connect to the cells to deliver power to electrical components such as the motors.

In some embodiments, an electric aircraft includes physically separated but electrically interconnected cells which share charge through balancing traces or wires, such as between arms under unbalanced loads. A benefit of this architecture are shorter primary current paths from the cells to the motors that they power, in addition to the improved cell mass/total vehicle mass ratio. In some embodiments, passive fuses or active battery protection circuitry are provided to isolate malfunctioning cells from the motors they power, enhancing reliability of systems with full powertrain redundancy.

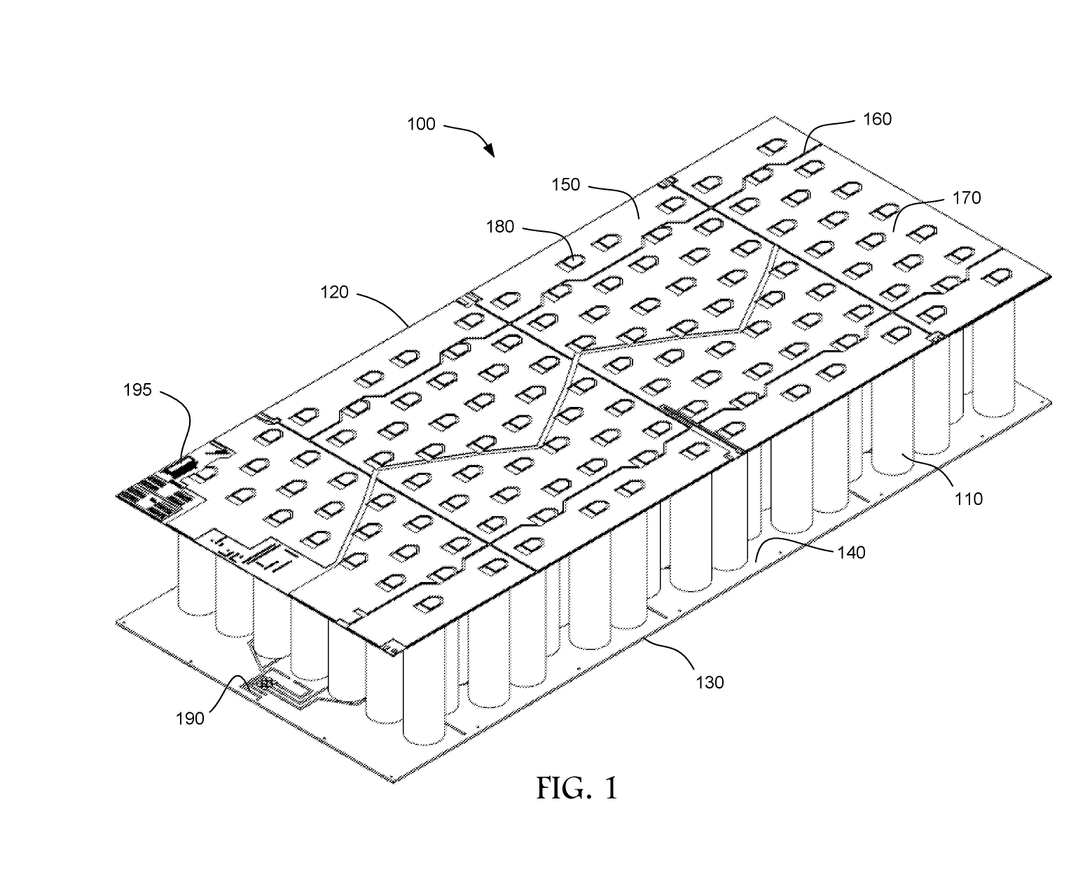

FIG. 1 illustrates an exemplary battery module 100 of the present invention. The battery module 100 comprises a plurality of electrochemical cells 110 secured to, and secured between, two planar substrates 120, 130, such that the assembly forms a load-bearing structure. As described further below, the structure is load-bearing in that it resists bending, torsional, compressive, and tensile loadings. While the battery module 100 may be sheathed for safety, cooling performance, or as part of the vehicle outer mold line, the cover does not meaningfully contribute to structural strength in some embodiments. As such, in some embodiments the battery module 100 consists of, or consists essentially of, a plurality of electrochemical cells 110 secured to and between the two planar substrates 120, 130.

Suitable electrochemical cells 110 include cells of the 18650 cylindrical cell format, as well as AAA, AA, C, D, the 26650 format, and the 21700 cylindrical format. Essentially, any prism-shaped cell with, for example, a rectangular, triangular, hexagonal, or oval cross-section can be used, but cylindrical cells provide advantages to the airflow therebetween, in certain embodiments, as discussed further below. Suitable cells 110 can also employ a lithium-ion NCA cathode with a blended silicon/graphite anode to achieve high specific energy. Cells with chemistry reasonably similar to this are commercially available today in the Panasonic NCR18650GA and LG Chemical INR18650MJ1. In other embodiments, NMC, LCO, LMO, NMCA, sulfur, or other cathode chemistries may be employed to achieve differing electrical properties. In other embodiments, pure graphite, pure silicon, metallic lithium, titanate, or other anode chemistries may also be employed. Essentially any battery cell chemistry packaged into the above cell formats may be a valid embodiment.

Planar substrates 120, 130 include metal traces or wires or other conductive means to distribute electricity from the cells 110 to electric systems such as electric motors when the cells 110 are discharging, and to recharge the cells 110 as needed, as well as to carry control and monitoring signals. Commercially available integrated circuits providing battery management, avionics, and the like can be placed on either or both planar substrates 120, 130 or separate planar substrates, as discussed further below.

Various accessory components (not shown) can also be added to one or both planar substrates 120, 130 to enhance the functionality and safety of the battery module 100. For example, each planar substrate 120, 130 can include a voltage sensor, shunt resistor, transistor and controller (or receiver) to passively bleed charge and balance cells 110 during charging. Additional such components can include thermistors, fans, heaters, and thermostats for cell thermal control. Battery protection circuits, provided with alternate current paths, may be included on the planar substrates 120, 130 to bypass certain cell groups (reducing voltage) to provide for cell failure tolerance. Finally, each planar substrate 120, 130 can also host a variety of flight sensors—whether inertial, pressure, or otherwise, enabling a “smart structure” able to provide feedback to a flight controller or pilot.

Suitable planar substrates 120, 130 can include PCBs, flex materials such as PET and PI films, engineering plastics and glass-reinforced plastics, Kevlar and carbon fiber composite pieces, and foams. PCBs can be formed not only from traditional fiberglass resin composites but also from other engineering substrates such as insulated aluminum, ceramics, and impregnated paper (FR-2). A suitable example of a PCB includes a 0.030″ FR4 substrate with 1 oz copper layers on either side. It should be noted that the planar substrates 120, 130 also provide an insulating layer between any metal layers thereon and the cells 110, such as the FR4 substrate in the above example.

It will be understood that the term “planar substrate” is meant herein to encompass not only flat substrates but also substrates that conform to shapes dictated by the shape of a vehicle. In embodiments such as the one illustrated in FIG. 1, both planar substrates 120, 130 are flat and are disposed essentially parallel to one another. In those embodiments in which the battery module 100 comprises an aerodynamic shape such as a fairing, nose cone, airfoil, or fuselage, the planar substrates 120, 130 are essentially parallel in that they are locally parallel such that the cells 110 disposed therebetween are aligned with their longitudinal axes perpendicular to the planes defined by both planar substrates 120, 130 at the points of connection. Suitable materials for planar substrates 120, 130, in various embodiments, have a surface energy or 30 mJ/m² or more in order for adhesives to adhere well thereto. Another property, in various embodiments, is an elongation to break of 1% or more.

In the example of FIG. 1, the planar substrates 120, 130 comprise PCBs having metal plating on both surfaces, inner surfaces 140 that face the cells 110, and opposing outer surfaces 150 that face away from the cells 110. In some embodiments, the planar substrates 120, 130 have the conductive means on only one surface, which can be either the inner surface 140 or outer surface 150. In FIG. 1, the metal on the outer surfaces 150 comprises a sheet of a uniform thickness of a metal such as copper, having gaps 160 defined therein to provide electrical insulation between electrically isolated sections 170 of the metal layer and other such traces formed from the metal layer. Here, large sections 170 that span several cells 110 electrically join those cells 110 in parallel; these sections 170 are sometimes called power planes or equipotentials.

The pattern of gaps 160 in the metal layers generally mirror one another on the opposing PCBs, and all cells 110 connected to a given section 170 are aligned so their currents are additive. In various embodiments, the number of cells 110 per section 170 is the same for all or many sections 170 in a battery module 100. Cells 110 in adjacent sections 170 can be aligned opposite one another, in various embodiments. Neighboring sections 170 can be connected in series or in parallel to provide current at the proper voltage. Such electrical connections can be provided through connections in the metal layer, or by wires that bridge over gaps 160, or the like, and can optionally include fuses.

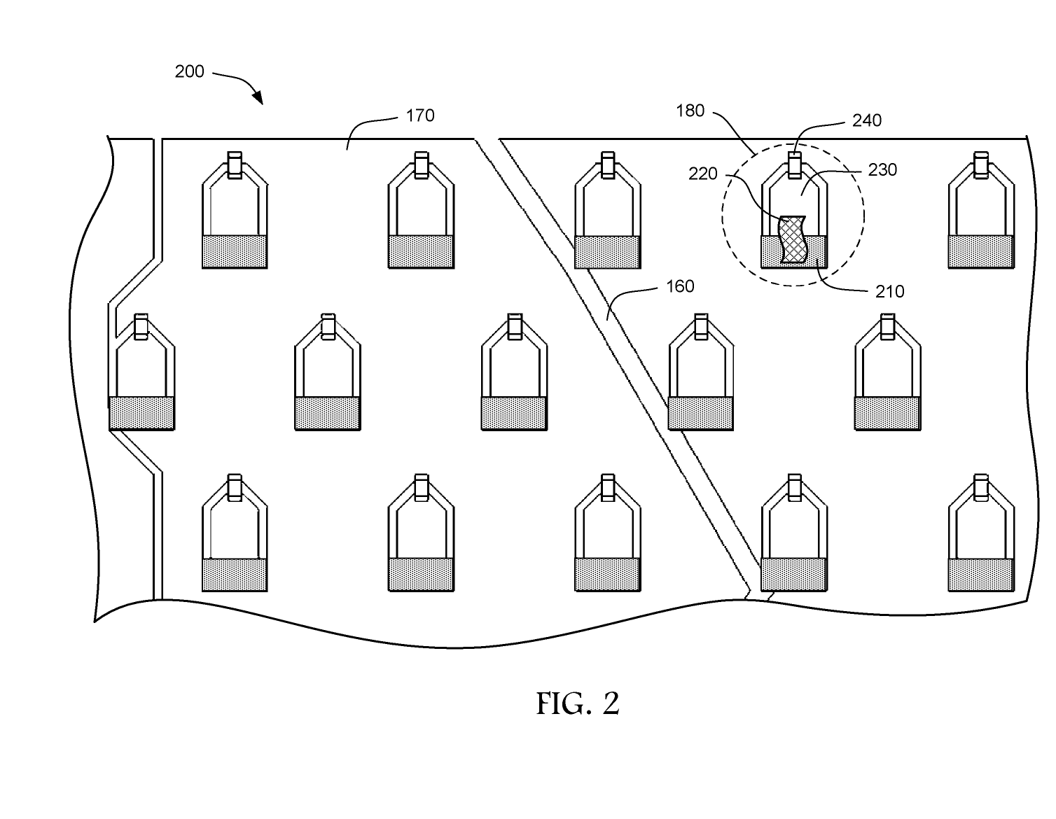

In various embodiments, the planar substrates 120, 130 comprise terminals 180 for making electrical connections between the cells 110 and the sections 170. FIG. 2 illustrates an enlarged view of a portion 200 of the surface 150 of planar substrate 120 of FIG. 1. In some of these embodiments, the current carrying metal sections 170 are on the outer surfaces 150 and the planar substrates 120, 130 additionally include holes 210 therethrough, one for each of the terminals 180. These holes 210 allow for a connection through the thickness of the planar substrates 120, 130 to the cells 110. The holes 210 advantageously further reduce the mass of the planar substrates 120, 130. In some of these embodiments the connection is made by an electrically conductive ribbon 220, such as nickel-plated copper, disposed through the hole 210. Other suitable compositions for the ribbon 220 include nickel, steel, aluminum, and copper optionally plated with tin, silver, nickel, or gold. A ribbon 220, as used herein, encompasses strips of material ranging in thickness from foils to thin sheets. Instead of ribbons disposed through holes in planar substrates, electrical connections through the planar substrates can be made by metal-filled vias, for example.

Terminals 180 optionally include a bonding pad 230 defined in the current carrying metal sections 170 by additional gaps 160 that surround the bonding pads 230, electrically isolating them from the remainder of the metal layer of the section 170. In these embodiments, the electrical connection to a cell 110 is made through the ribbon 220 to the bonding pad 230, such as by soldering, welding, or adhering the ribbon 220 with an electrically conductive adhesive, for example. The connection of the ribbon 220 to the cell 110 can be made, for instance, using resistance, ultrasonic, or laser welding, or electrically conductive adhesives. Other embodiments do not include defined bonding pads 230, as such, and the electrical connections are made directly to the section 170.

FIG. 2 also shows a fuse 240 for each terminal 180 that electrically connects the bonding pad 230 to the remainder of the metal layer of the section 170. In those embodiments in which the terminals 180 lack defined bonding pads 230 and fuses 240, the connections between sections 170 of the metal layer can optionally be connected with fuses. In various embodiments, the fuses 240 can comprise narrow traces defined in the metal layer that connect the bonding pads 230 to the larger sections 170, or can comprise welded thin ribbons or wire interconnects, designed to fuse at the appropriate current. In other embodiments, the fuse 240 comprises a surface-mounted fuse such as the Bel Fuse C1H series. A separate fuse 240 for every cell 110 better protects against external shorts, enhancing electrical safety. In some embodiments, fuses 240 may be present for only the positive connections, or only the negative connections, or neither.

Returning to FIG. 1, the planar substrates 120, 130 also include metal traces 190 on the inner surfaces 140 facing the cells 110. In this embodiment, these traces 190 permit monitoring of the cells 110 for voltage sensing and cell balancing purposes, and can also carry control signals. As noted, FIG. 1 shows an exemplary arrangement in which one side of each planar substrate 120, 130 is used primarily for the conduction of electricity from, and back to, the cells 110, while the other side is used primarily for control and monitoring, but all of the functions can be performed on just one side, and the present invention also embraces multi-layer planar substrates 120, 130 in which electrical conduction is provided along buried conduction layers, patterned in the same manner as already disclosed. As needed, soldermask, conformal coating, and/or a gap-enforced adhesive can be used to insulate the cells 110 from these metal layers.

In various embodiments, the cells 110 are secured to both planar substrates 120, 130. The term “secured” is used herein according to its ordinary meaning of fixed or attached firmly so that it cannot be moved. As such, securing the cells 110 to both planar substrates 120, 130 provides a rigid structure capable of carrying loads. Various techniques, alone or in combination, can be used to secure the cells 110 between the planar substrates 120, 130 including bonding through the use of adhesives such as epoxies, soldering, welding, as well as the use of tensioners (not shown) attached to both planar substrates 120, 130 and spanning therebetween to provide a compressive load to the cells 110. Suitable tensioners include, for instance, high-strength wires, fasteners, threads, and cable ties. Threads and wires can be weaved through holes or grommets in the planar substrates 120, 130, analogous to the design of a biplane wing, to add further torsional and bending stiffness. To add further resistance to peel, small flanges or brackets (not shown) mounted to one or both of the planar substrates 120, 130 can be used to bracket the cells 110 from one or more directions and enhance the strength of the cell-substrate bond.

Though not illustrated, it is noted that in some embodiments that do not employ an adhesive, compliant spacers are selective placed, such as around the positive terminals of the cells 110, with thru-holes for the terminals, that sit in between the cells 110 and the planar substrates 120, 130. These spacers, in some instances about 1 mm thick, can be made of foam, springs, or of cut rubber such as EPDM/neoprene can be used to compensate for normal variances in cell heights. In embodiments that do not employ an adhesive to secure the cells 110, other spacers, such as a laser or blade-cut polyethylene foam honeycomb, can be placed between cells 110 to maintain minimum cell spacing to ensure electrical creepage and clearance requirements are met.

Physical loads, such as electric motors, control surfaces, avionics, etc., can be mounted to the battery module 100. Three clearance holes on a single planar substrate 120 or 130, or two clearance holes on one and a third clearance hole on the second substrate, for example, provide a satisfactory mounting arrangement to constrain a load in six degrees of freedom.

As noted previously, various control systems can be integrated into the battery module 100. Control systems can include a battery management and protection system that includes resistive or charge shuttling cell balancing, temperature sensing, overcharge protection, over-discharge protection, cell voltage sensing, current sensing, state of charge/energy estimation, state of health estimation, and telemetry. Such functionality can be provided in one or more discrete components 195 mounted on one or both of the planar substrates 120, 130. Discrete components 195 can include battery balancing ICs such as the Linear Technology LTC6811 which can also be added, along with the accompanying transforming hardware (such as one LT8584 and accompanying discrete components per series count), to enable onboard charge shuttling between battery modules 100. Discrete components 195 can also include sensors and connectors, for example, in addition to ICs.

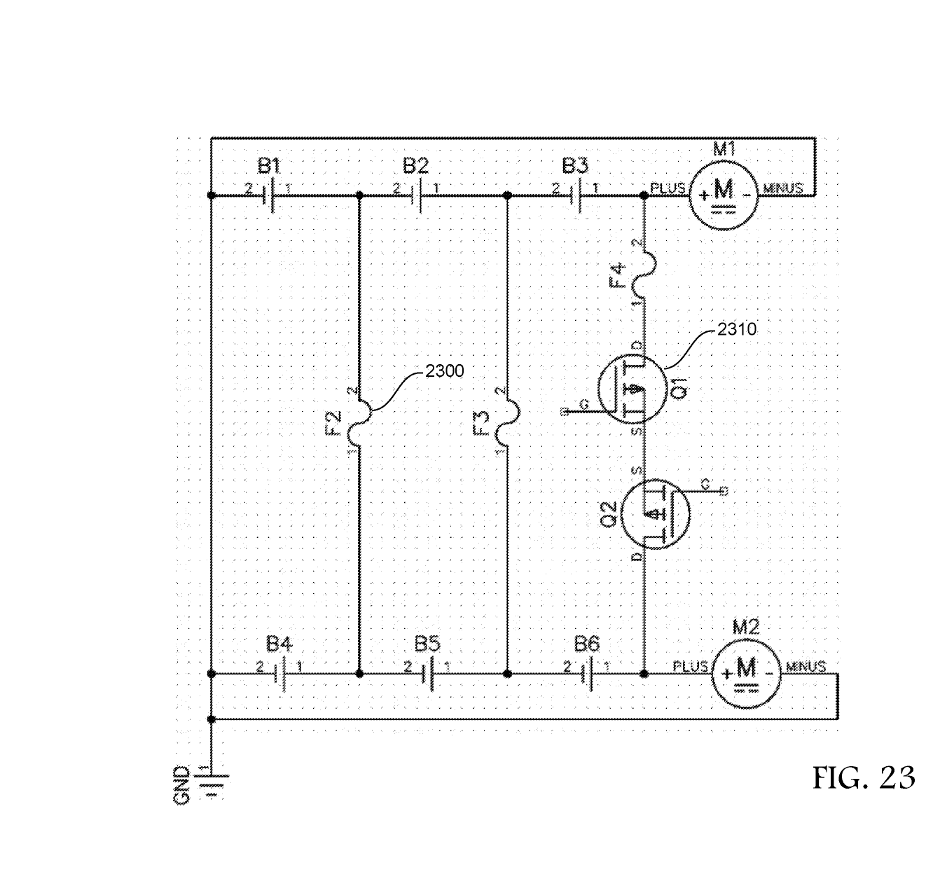

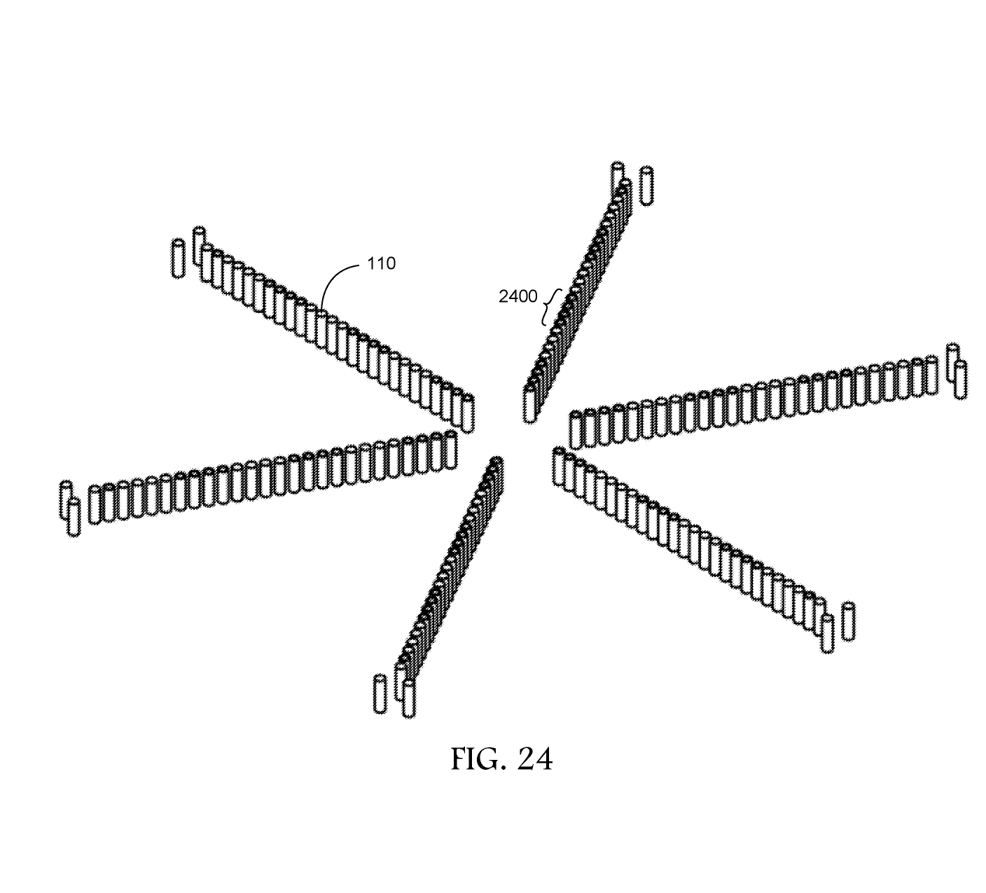

Discrete components 195 can include a microcontroller (such as an ATMega series) capable of driving a set of power transistors, either through logic-level direct drive or through a FET driver IC (See FETs 2310 in FIG. 23), to connect or disconnect the battery module 100 from a load. The microcontroller also can control battery cooling fans or heating means, as discussed further below. In other embodiments, some or none of the above battery management functionality may be included. In other embodiments, some or all of the discrete components 195 can be disposed on a separate circuit board (not shown) in electrical communication with the planar substrates 120, 130. In embodiments without a battery management system, voltage sense traces may be extended to a central position with a connector used for off-board battery balancing by a multi-pin charger (not shown).

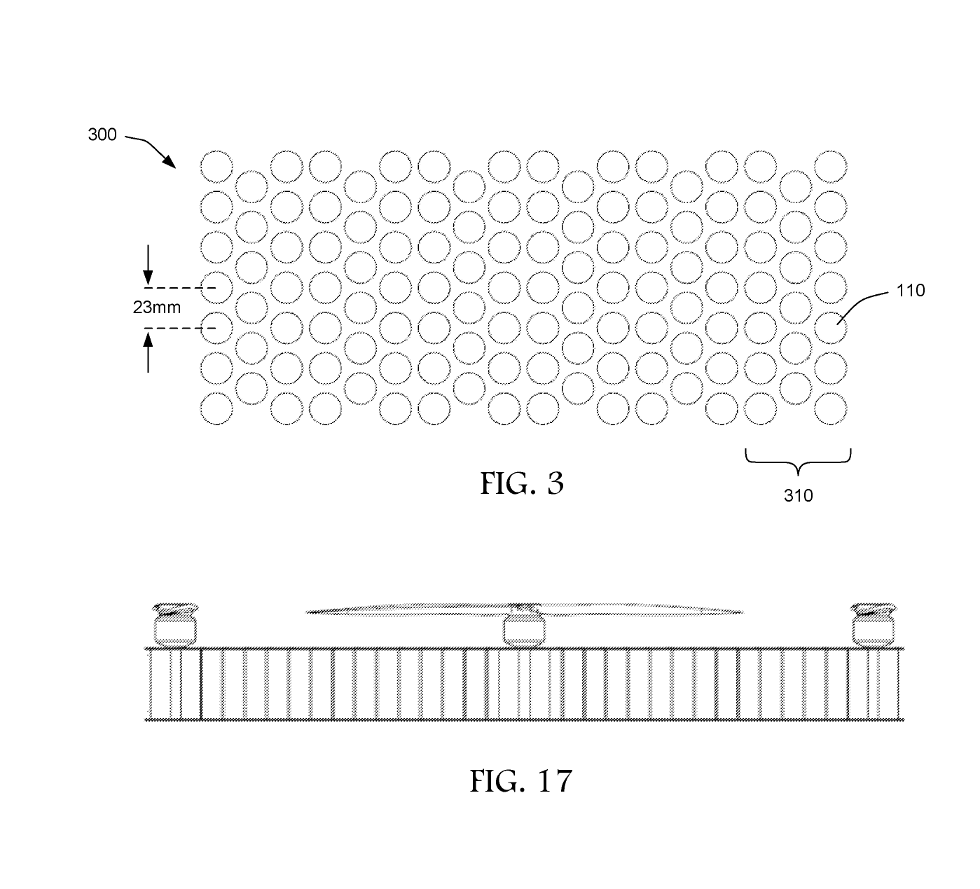

FIG. 3 provides a schematic illustration of just one suitable cell grid 300 with a to-scale cell spacing according to an exemplary embodiment that employs cells 110 of the 18650 cylindrical cell format. Cells 110 pitched 23 mm center-to-center provide adequate airflow around and between the cells 110, in this example when driven by a cooling fan. In this embodiment, three rows of cells 110 comprise a repeating unit 310 that are stacked together. Choice of cell grid arrangement is an engineering decision based, at least in part, upon the required cooling and available blowing pressure head/volume rate. Hexagonally close-packed configurations of cells 110 provide low pressure drops with forced-air cooling systems, described in greater detail below. In other embodiments, cells 110 may be packed with different spacings to increase packing efficiency or thermal performance, and also may be packed in non-hexagonally symmetric configurations.

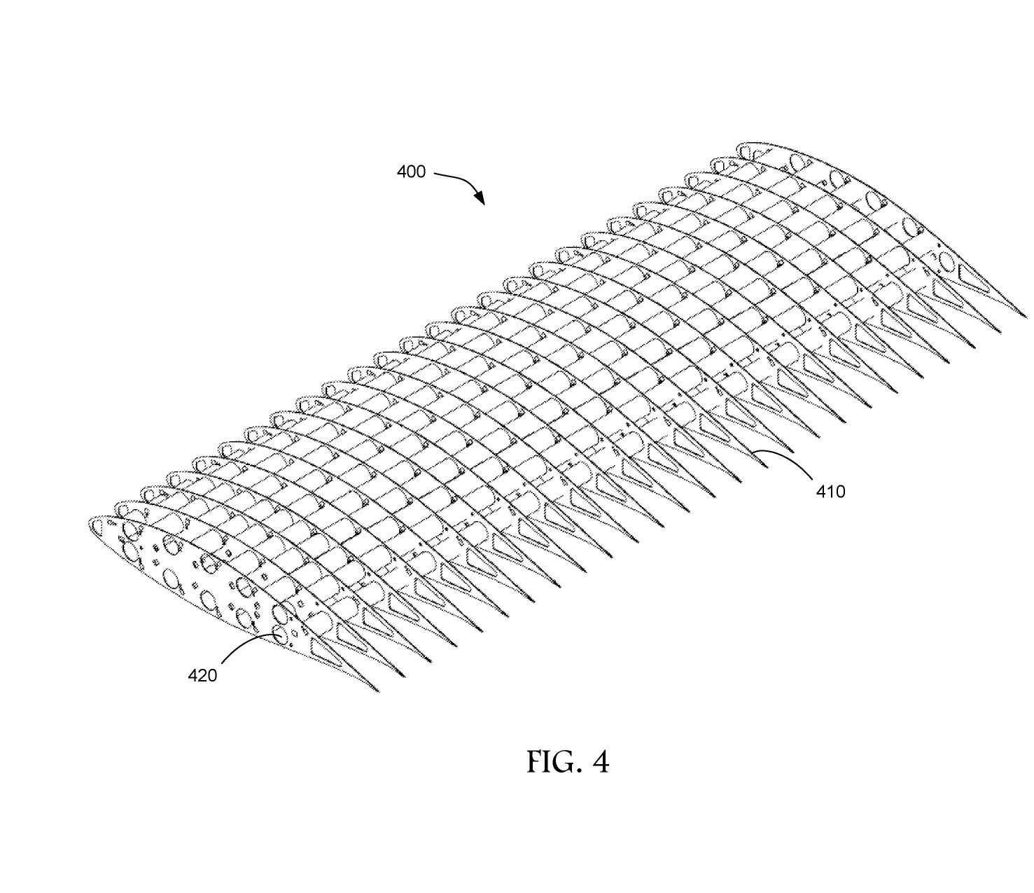

FIG. 4 provides an illustration of a battery module 400 according to another exemplary embodiment. In this embodiment, the planar substrates 410 have a footprint, or planform, in the shape of an airfoil rib. As such, it can be seen that the battery modules such as battery module 100 can be extended with multiple additional planar substrates to form extended load-bearing structures such as electric aircraft wings as in battery module 400. In these embodiments, the longitudinal rows of cells 110 form parallel spars while the planar substrates 410 serve as ribs. In other embodiments, these orientations are reversed such that the cells 110 are used as ribs and the planar substrates 410 comprise spars.

Structures comprising multiple stacked planar substrates allow for further arrangements of cells 110 in which the cells 110 are staggered relative to one another as illustrated in FIG. 4, as compared to the prior embodiment of FIG. 1 in which the cells 110 are simply arranged in a single layer. In the embodiment of FIG. 4, at least some planar substrates 410 include apertures 420 therethrough where the apertures 420 are sized to accept a cell 110 disposed longitudinally therethrough. In other words, the diameter of the apertures 420 is sized to be greater than a diameter of the cell 110, but no larger than necessary for the cell 110 to fit snuggly therein. Planar substrates 410 at the ends of the module 400 need not have such apertures 420 but may still include them as the apertures 420 also lessen the overall mass of the planar substrates 410. Additional apertures can be included even where space is too limited for cells 110, as shown, just to further reduce mass.

In some embodiments, the cells 110 are staggered such that half of the cells 110 make electrical contact only to successive even numbered planar substrates 410, e.g. the 4^{th} and 6^{th} planar substrates 410, or successive odd numbered planar substrates 410. In these embodiments, where a cell 110 passes through an aperture 420 in another planar substrate 410, the cell 110 can be secured to this intermediate planar substrate 410 using a non-electrically conductive adhesive. In other embodiments, a positive terminal of the cell 110 is electrically connected to a planar substrate 410 in the manner discussed above, while the negative connection to the cell 110 is made through the sidewall, also referred to as the can, of the cell 110 at the aperture 420 of an adjacent planar substrate 410. Electrical connections between the cans of the cells 110 and the planar substrates 410 at the apertures 420 can be achieved with electrically conductive adhesives, for example, which also serve to secure the cells 110 to the planar substrates 410. Staggering cells 110 in this manner is discussed further with respect to FIG. 6. It is noted that a 400V assembly (about 96 cells 110 in series) of 18650 lithium-ion cells 110 would result in a semi-wingspan of 6.5 meters—similar to that of a Cessna 172.

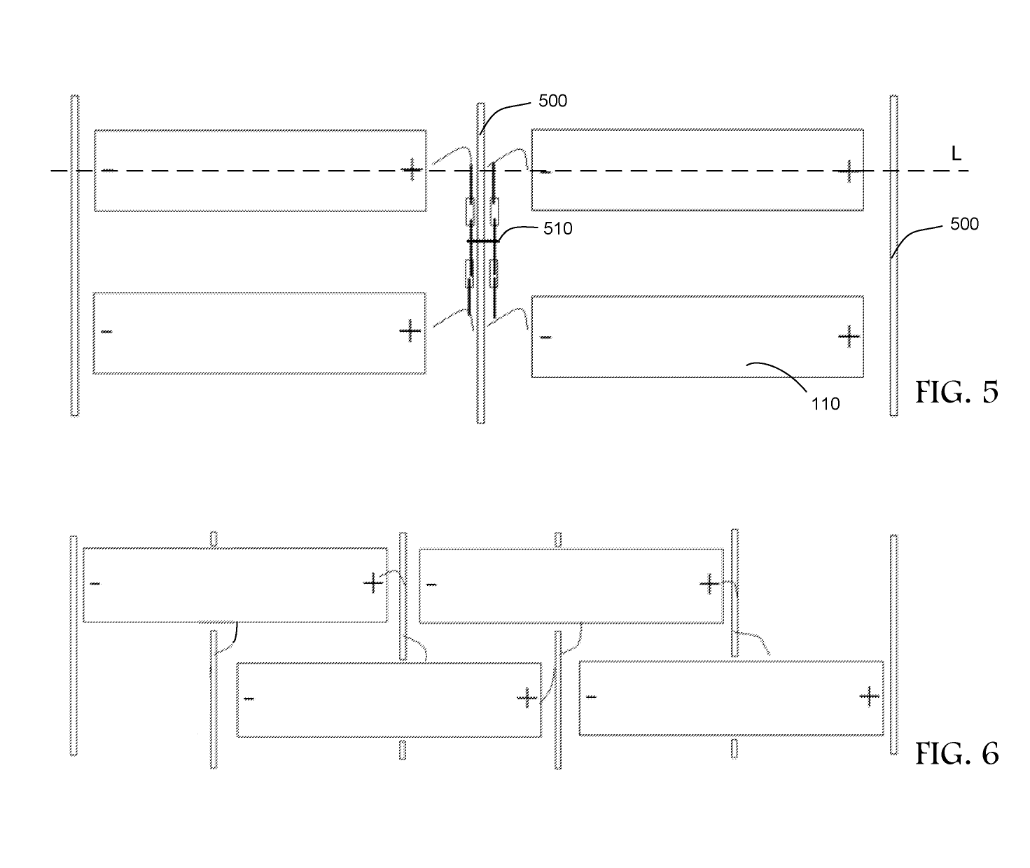

FIG. 5 is a schematic representation of three successive planar substrates 500 having cells 110 secured therebetween. In this embodiment, the cells 110 are secured to the planar substrates 500 on either side in the manner discussed above. In this example, the cells 110 in successive layers are aligned coaxially, that is, cells 110 form rows across the layers where each cell 110 of the row shares a common longitudinal axis, L. However, in other embodiments, the cells 110 of successive layers are not coaxial, though they may be in every second layer or every third layer, for example. Staggering cells 110 in this manner provides clearance around the interconnects (e.g., terminals 180), and also provides venting space above and below the cells 110 to help prevent lithium-ion runaways. Planar substrates 500 are configured, in these embodiments, such that interconnects on opposite sides of the planar substrate 500 are electrically connected. In this way, the cells 110 in successive layers can be arranged, as shown, to be connected electrically in series. In FIG. 5, a line 510 represents the connection between sides of the planar substrate which could be a metal plug within a via through the planar substrate 500, for example.

FIG. 6 is a schematic representation of an arrangement in which cells 110 are staggered in the manner described with respect to the embodiment of FIG. 4. Here, the cells 110 are secured to planar substrates 600 in the manner discussed above. In this particular embodiment, the positive topcap of each cell 110 is connected to a terminal 180 (FIG. 2) while the side 610 of the cell 110 is used for the negative connection and is electrically connected to the planar substrate 600 through which it passes, such as with conductive epoxy. This connection to the side 610 of the cell 110 is represented by line 620, and can also be made by welding, soldering, or any other metal joining technique discussed herein. The cells 110 are staggered by a fraction of the cell length, such as by a half (as shown) or by thirds. The cells 110, in these embodiments, can also be staggered in the manner described with respect to FIG. 5 to not be coaxial from one layer to the next. Planar substrates 600 are configured, in these embodiments, such that interconnects on opposite sides of the planar substrate 600 are electrically connected. In this way, the cells 110 in successive layers can be arranged, as shown, to be connected electrically in series. It is noted that, in addition to the bonded electrical connections such as welding and soldering, electrical connections can be made to one or both of the positive and negative polarities of the cells 110 by a spring-loaded connector, or other non-bonded electrical connection.

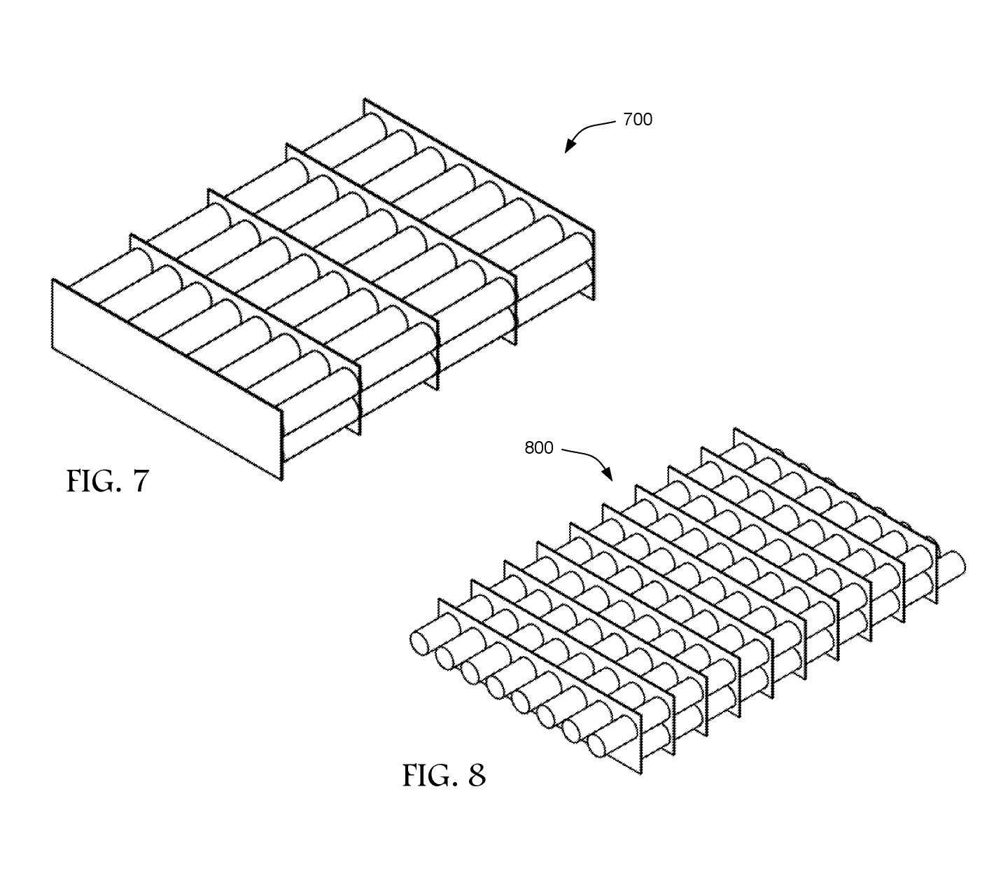

FIGS. 7 and 8 show, respectively, a battery module 700 constructed according to the arrangement of FIG. 5 and a battery module 800 constructed according to the arrangement of FIG. 6. The substrate-cell-substrate unit can be repeated along the longitudinal axis of the cells 110 to add both voltage and length to the battery module 700, 800. In those embodiments in which all cells 110 are oriented in the same direction, such as in FIG. 5, one end of the battery module 700, 800 carries the highest voltage (Pack+) while the other end carries Ground. A bus bar or cable (not shown) can be used to connect an electrical load, in these embodiments. As noted, other embodiments can have equal numbers of cells 110 oriented in opposite directions. In these embodiments, the planar substrate 500, 600 at one end of the battery module 700, 800 can include an electrical U turn in order to place both the Pack+ and Ground terminals (not shown) at the other side of the battery module 700, 800.

In some battery modules 700, 800, each planar substrate 500, 600 represents an equipotential and thus connects the same sides of similar-voltage cells 110. By contrast to the battery module 100 in which planar substrates 120, 130 have metal layers patterned with gaps 160 to create sections 170 of equipotential, there is only one such section per planar substrate 500, 600 in these embodiments, though planar substrates 500, 600 can still be patterned to create traces for various purposes.

Planar substrates 500, 600 can, of course, have sections 170 to provide two or more voltages to match the desired cell counts with real world geometry. For instance, a short wing which needs to produce a high voltage or a tapered wing where the large base holds +1series and +2series cells 110 while the small end only holds one series count. Inversely, multiple PCB's may contain cells of the same voltage through appropriate interconnecting and busing. Long wings of low voltage require cells 110 on different planar substrates 500, 600 to be put in parallel. To fit the form of real aircraft structures, the number of cells 110, their locations, as well as the footprints of the planar substrates 500, 600 may change with each successive layer. By doing so, the forms of a wide variety of aerospace structures can be created, including fuselages, landing gear, pods, tails, hubs, ducts, and more.

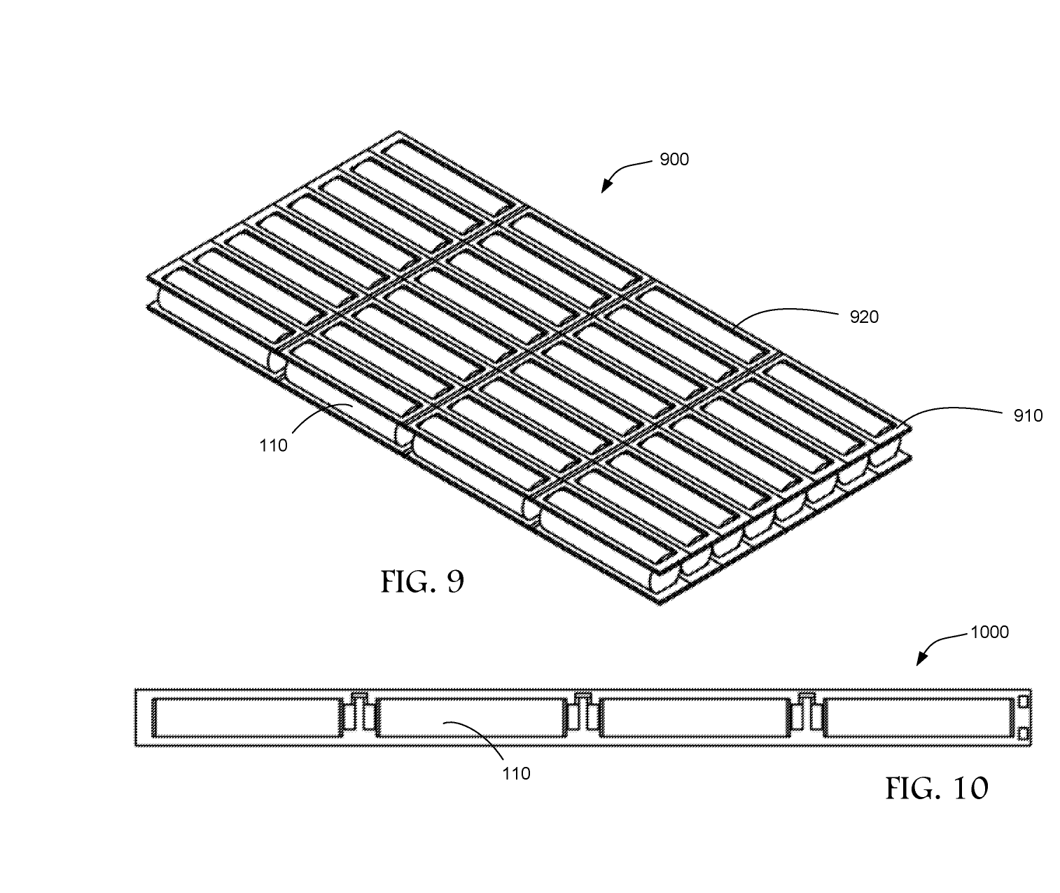

FIG. 9 shows a perspective view of still another battery module 900 of the present invention, while FIG. 10 shows a top view of a battery module 1000 comprising a single column of cells 110, and as such, is also representative of a top view of a column from battery module 900. The embodiment of FIG. 10 can be used as an arm of a multirotor aircraft, for example. Planar substrates 910 include a number of rectangular slots 920 that are at least as long as the cells 110, but narrower than a diameter thereof. One cell 110 is disposed in each slot 920 and engages with the slot 920, and in some embodiments partially protrudes through the slot 920. The displacement of two planar substrates by less than the diameter of a cell creates a rigid honeycomb/composite beam structure. In still other embodiments, the planar substrates are displaced by a cell diameter by being affixed along a line on the surface of the can of the cells 110.

Providing the slot 920 with a longer length than the height of the cells 110 allows for normal manufacturing variations in the cell height, and also allows for cells 110 to expand. Cells 110 can swell from continued use. Additionally, battery modules operate within a temperature range, and if the coefficient of thermal expansion (CTE) is greater for a cell 110 than the surrounding planar substrate 910, then the cell 110 will undergo a greater dimensional change than the planar substrate 910 as the temperature of the module increases across the range.

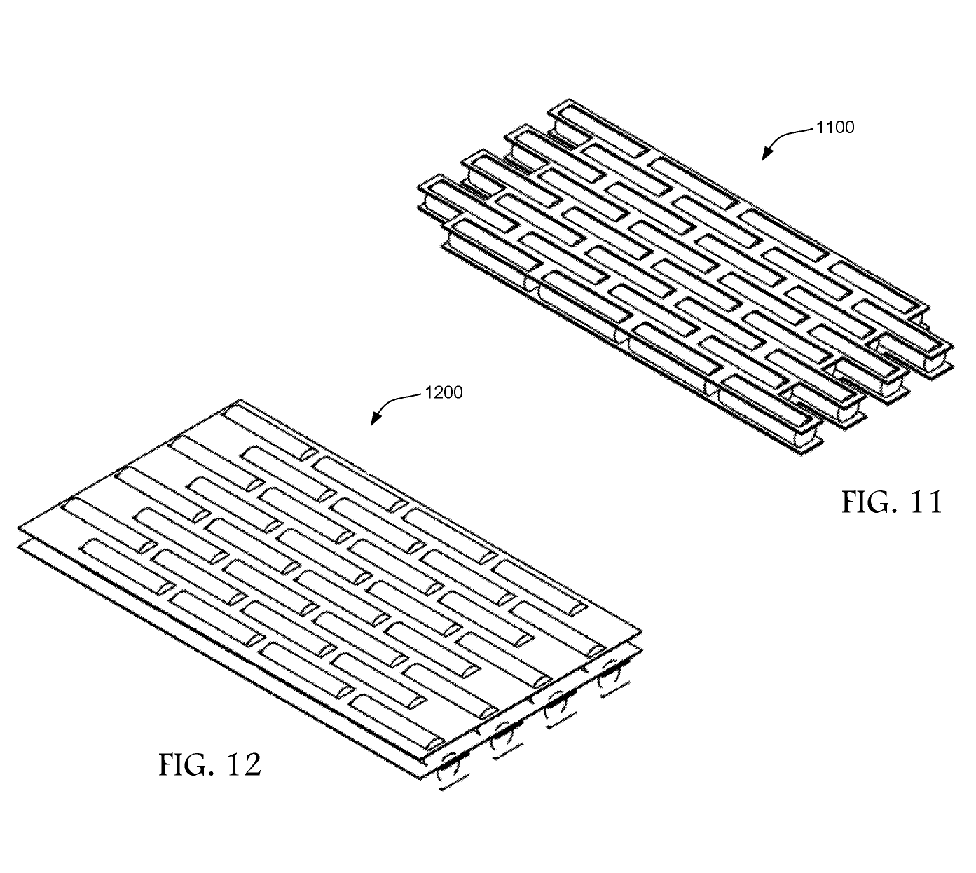

FIGS. 11 and 12 show perspective views of still further battery modules 1100, 1200 of the present invention. The battery module 1100 is constructed in the manner described for battery modules 900, 1000 but in this example the cells 110 in alternating columns are staggered, in this example by half of a cell height. The battery module 1200 extends the structure to further parallel layers, as shown. The cells 110 in successive layers can also be staggered, in this case offset in the transverse direction.

The embodiments of FIGS. 7-9, 11, and 12 can be further formed to meet the many non-rectangular designs in aerospace structures such as fuselages, wings, pods, and tails, and for UAV structures like arms, frames, motor mounts, and landing gear. This is achieved by varying the footprints of the planar substrates and varying the number of cells in the lattice to work within the available space. One way to design battery modules for an aerospace structure is to first establish footprints, or outlines, for the battery module, or modules if multiple modules are to form a larger assembly, to assume the approximate cross section of the structure. Appropriate mounting points for coupling to secondary structures and loads can be added. In the embodiment of a wing (FIG. 4), this footprint may be long and tapered, with an aspect ratio of 5-20:1. In those embodiments in which the planar substrates comprise PCBs, or some other substrate having metal layers, the metal layers can optionally be segmented into sections 170 as needed to optimize part cost and shipping logistics.

Cell positions are then established to, for example, minimize current path length, maintain regulatory creepage and clearance distances, provide appropriate clearances on all sides of the cells 110 to prevent thermal runaway propagation, and limiting structural discontinuities. Staggering cells 110 longitudinally is one way to limit structural discontinuities. In some embodiments, space can also be provided for thermal control features such as fans and heaters, discussed further below. Cells 110 and cell slots 920 (if used) are then spaced such that cells 110 of similar potentials (series-counts) are proximal. Successive series counts are then placed adjacently—most efficiently, head-to-tail longitudinally. Sections of a metal layer are designed onto the PCBs to bus current from one cell group to the next. In embodiments involving contoured shapes, planar substrates can optionally be thermally formed or strained with board-mounted components already included before assembly.

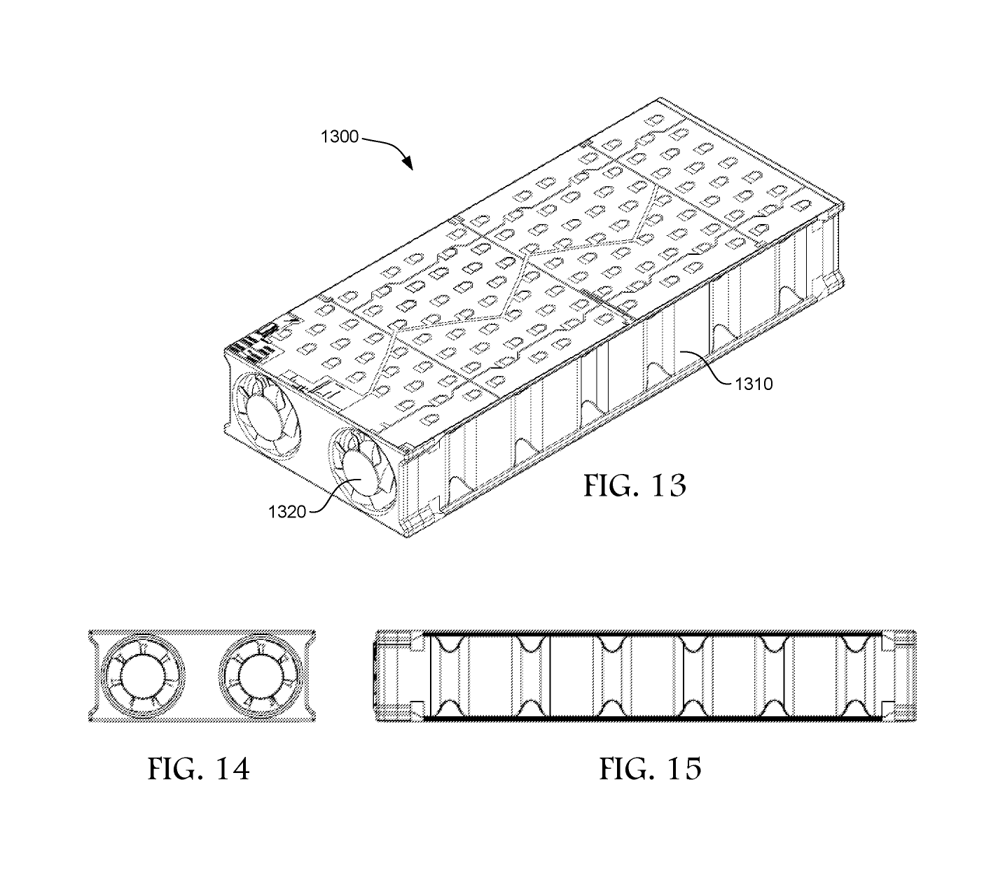

FIGS. 13-15 show perspective, side and front views, respectively, of an exemplary battery module 1300 including a housing 1310 having fans 1320. The embodiment shown in these drawings can be the battery module 100 (FIG. 1) with the addition of housing 1310. The housing 1310, in this embodiment, encloses the four open sides defined between the two planar substrates 120, 130. In various embodiments, sides of the housing 1310 can be formed from thin gauge plastic (˜0.005″ polycarbonate as one example), such as by vacuum forming, with openings defined therein as needed for features such as vents and fans 1320. The plastic, in some embodiments is formed as flat sheets, but in other embodiments the plastic is formed to improve or manifold forced airflow. For instance, by forming the plastic of the housing 1310 adjacent to the end row of cells 110 to mimic the shape of a next row of cells, the air flow between that row of cells 110 and the side of the housing 1310 is much more like the flow between the cells 110 deeper within the battery module 1300, improving temperature uniformity. In addition to covering the exposed sides of the battery module 100, housing 1310 can be optionally disposed over and below the planar substrates 120, 130 to further insulate these components. In other embodiments, the battery module 500 may be enclosed with shrink wrap, and the housing 510 formed of composites, or with additional connecting PCBs or flexible circuits.

In the embodiment of FIGS. 13-15, ambient air is circulated through the matrix of cells 110 using one or more fans 1320 controlled, for example, by the battery management system. More or less airflow is required depending on the power profile required compared to the internal resistance of the cells, and air may be circulated either for heating or cooling. Cooling can enhance longevity and discharge rate capability, for example, while heating can improve a cell's capacity by lowering its resistance. In some embodiments, the air may be heated or chilled by an external HVAC system (not shown). Heating can also be achieved by resistive heaters placed within the battery module 1300. In embodiments optimized for higher thermal performance, larger total sizes, or greater volumetric efficiency, liquid or phase change cooling systems may fill the spaces between cells 110. For example, battery module 1300 can be sealed with a dielectric liquid inside the housing 1310 and in a saturated atmosphere, where the liquid has a boiling point in the proper range; the liquid boils off of the cells 110 and then condenses on a radiator elsewhere in the assembly to remove heat.

Electrical connections between planar substrates 120, 130 (not shown) can be used to join points of equal potential between adjacent planar substrates 120, 130. PCBs, for example, may be electrically connected using harnesses, flex circuits, or board connectors. In embodiments in which a battery management system manages both planar substrates 120, 130 but is disposed on only one of them, such a connection is necessary so that the battery management system has access to the cell voltages collected on the other planar substrate.

Main power bus connections to the battery modules 100, 400, and 700-1300 can be achieved by terminal connectors (not shown) that are soldered or welded, for example, onto open areas on the metal layer of the planar substrate 120, 130 or through holes thereof. In other embodiments, power connector wires may be directly soldered to these places without resort to terminal connectors.

For embodiments in which higher powers are needed to boost voltages for temporary current transients, a battery module can include a separate series stack of high-power cells 110 that is electrically segregated from the other cells 110, and selectively connected to the remainder of the battery module by turning on power transistors or using some other power relay mechanism.

Further embodiments are directed to multirotor aircraft, such as quadcopters, though three or more rotors can be used. Due to the greater endurance provided by these designs, some embodiments can be advantageously used for extended periods for photography, surveillance, and surveying. These embodiments can carry little additional mass beyond that of the structural battery modules, rotors, motors, and controllers. Additional components can be limited to digital cameras, transceivers, and optional GPS modules, such as a GPS micro-chip. Still further embodiments are directed to hybrid electric multirotor aircraft.

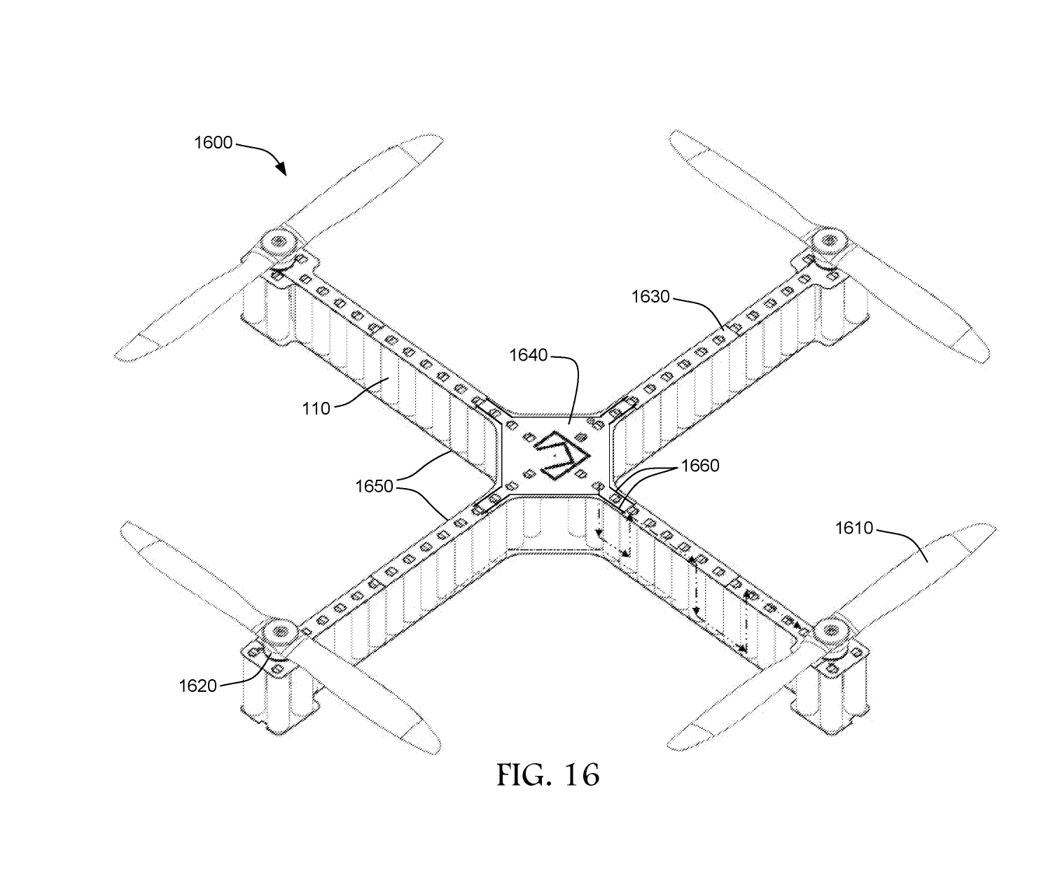

FIG. 16 illustrates an exemplary embodiment of a multirotor aircraft 1600 comprising four rotors 1610 each driven by an electric motor 1620. FIG. 17 shows the same aircraft 1600 from a side view. The motor/rotor combination is set at the end of an arm 1630 extending from a central hub 1640. Locating the rotors 1610 away from the center axis of the aircraft 1600 provides roll and pitch control, with yaw control provided by transferring momentum to and from the rotors 1610. In this embodiment, each arm 1630 comprises a sandwich of cells 110 arranged between planar substrates 1650 as shown in FIGS. 1 and 10. In various embodiments, a lightweight vacuum formed or foam shroud is attached to the vehicle's arms 1630 to improve its aerodynamic properties and reduce drag on the thrust stream. The shroud furthermore can be used to improve impact tolerance. FIG. 16 also illustrates the primary current path in an arm 1630 (arrows), following through the periodically inverted battery cells 110 to a motor controller and motor 1620. FIG. 16 also illustrates select secondary current paths 1660 between equipoentials on different arms 1630 for cell balancing.

In some embodiments, the planar substrates 1650 have a footprint of the planform of the quadcopter such that the central hub 1640 and the four arms 1630 are integral. In some embodiments, the cells 110 are secured to the planar substrates 1650 with an adhesive. In other embodiments, the cells 110 are not adhered but instead are mechanically secured with tensile wire, fasteners, thread, or clamps, for example. Some of these embodiments include a compressive material between the cells 110 and the planar substrates 1650 to accommodate variations in the cells 110.

In various embodiments, the planar substrates 1650 each comprise a circuit board made of a 0.030″ thick FR-4 substrate having two layers of 1 oz thickness copper plated with lead-free solder backing. However, in other embodiments thicker copper is used to enable higher current densities. The thickness of the FR-4 may be varied as well to alter mechanical properties. Further, metallic substrates such as used in PCBs made from insulated aluminum substrates, can be used to offer higher heat spreading properties for configurations in which onboard power electronics, battery management, charging, DC-to-DC voltage converters, and motor controllers can see performance or longevity improvements from sinking heat to the rest of the airframe. Substrate thickness may also vary to satisfy structural requirements. Electrical interconnects, in some of these embodiments, are made by resistance welding nickel ribbons to the positive and negative terminals of cells 110, the ribbons are passed through holes 210 in the PCBs and are reflow soldered to unmasked lead-free bonding pads 230 on the outer surfaces 150.

SMT fuses, such as the Bel Fuse C1H, can be used to connect bonding pads 230 (FIG. 2) to sections 170 on the PCBs, as discussed above. Connections to the positive and negative potentials of cells 110 can also be made by laser or ultrasonically welding a foil to the cell 110, ultrasonically welding a wire, or other techniques, and in the other embodiments, can be joined to the bonding pads 230 with an otherwise soldered, welded, or adhered joint.

In various embodiments, the cells 110 comprise the 18650 format and employ a lithium-based chemistry. Other embodiments employ other cylindrical cell form factors, such as AAA, AA, C, D, 21700, and 26650, for example. Non-cylindrical cells 110 also may be used, as well as non-lithium based rechargeable cells 110. Different cell geometries may be employed to change the aerodynamic, structural, or electrical properties of the resulting electromechanical assembly. It is noted that 72 of the 18650 format lithium-ion cells 110 are used in the embodiment of aircraft 1600 where the cells 110 are arranged in groups (strings) of twelve cells 110 in parallel, and six strings are placed in series (6S, 12P) for a total of approximately 3.6 kg of cell mass and 900 Wh of energy. In some embodiments, as much as 70%, 75%, and 77% cell mass/vehicle mass ratio is achievable in these embodiments after adding motors 1620 and avionics. At just a 70% cell mass/vehicle mass ratio, for an aircraft 1600 carrying 3.6 kg of cell mass having 900 Wh of energy, the aircraft specific energy is about 175 Wh/kg. In some embodiments, over 80% cell mass/vehicle mass ratio is attainable.

The planar substrates 1650 can bus current both spanwise out to the motors 1620 and towards the center axis of the vehicle 1600 for regulation and avionics power. As noted previously, some configurations include cells 110 that are electrically interconnected only to one planar substrate 1650. In these configurations both the positive topcap and the can of the cell 110 are electrically connected to conductors on the same planar substrate 1650. As one example, the positive topcap can be bonded in the manner described above with a metal ribbon extending through a hole in the planar substrate 1650, while a weld to the shoulder of a cell 110 forms the negative connection. It will be appreciated that this manner of connecting both positive and negative potentials to the same planar substrate 1650 can be applied to the other battery module embodiments discussed herein.

The electrical interconnects between the cells 110 and planar substrate 1650, in some embodiments, comprise a wire or nickel ribbons 220 resistance welded to the positive topcaps and the negative cans of the cells 110. Laser or ultrasonically welding can be used in place of resistance welding, in some embodiments. The ribbons 220 are passed through holes 210 and reflow soldered to unmasked lead-free bonding pads 230 on the outer surfaces 150. Welding or conductive adhesive can also be used in place of soldering. SMT fuses, such as the Bel Fuse C1H series, connect the bonding pads 230 to metal layers on the planar substrates 1650.

In some embodiments of aircraft 1600, a flight controller, GPS module, radios, motor controllers, sensors, and a battery management system are all included onboard the planar substrates 1650. Extra conducting layers can be connected to enable the greater schematic complexity of modern flight controllers.

In some embodiments, the outer surfaces 150 include metal layers that are predominantly employed for current collection, power busing, cell interconnections, and fusing, while metal layers on the inner surfaces 140 are used for data traces, voltage sensing, current return loops, and battery balancing and management. However, in other embodiments additional layers are included to route traces for battery management systems, flight control electronics, power systems, or other avionics.

In various embodiments, each arm 1630 of the multirotor aircraft 1600 contains cells 110 in a series and parallel configuration to reach the full potential required by the motor inverter/speed controller for that arm 1630. Inverter power transistors (not shown) can be integrated into each of the distal ends of at least one of the two planar substrates 1650 or disposed on an additional substrate (not shown), in either case, directly adjacent to a motor 1620. In steady flight, and with a perfectly balanced cells 110 within each arm 1630, all the current required for each motor 1620 is sourced from cells 110 within the supporting arm 1630. In unbalanced flight, power can be bused between different arms 1630 through board traces connecting each series-count of cells in parallel.

Embodiments also exist in which cell 110 positioning are determined by other factors. For example, cells 110 can be used as primary structure for the vehicle's core. In other embodiments, some or all cells 110 can form structure directly beneath each rotor 1610 which is an advantageous configuration for minimizing cantilevered weight, with lightweight structural/electrical connections between the rotors 1610 yielding a rigid vehicle. In some instances, cells 110 are used structurally as landing gear, or can simply be located beneath the motor 1620 to minimize bending loads.

In some configurations, a flexible circuit interconnect (not shown) provides electrical connections between the two planar substrates 1650 for battery management. Alternatively, connectors, soldered harnesses, or other conductors can be used. In some instances, substrate-to-substrate connectors or other means of electrical interconnection can add torsional rigidity to the arm 1630 in addition to providing connections between planar substrates 1650. Exemplary flexible printed circuits suitable for use in the present invention are disclosed in US Patent Application pre-Grant Publication 2014/0212695 A1 by Lane et al. and published on Jul. 31, 2014 which is incorporated herein by reference.

In further embodiments, a battery management system resides in the hub 1640 of one or both of the planar substrates 1650 and provides functionality including overcharge protection, over-discharge protection, voltage balancing, over-temperature protection, power projection and state of charge estimation, along with various vehicle-level telemetry. The battery management system may be highly integrated with a flight controller of the multirotor aircraft 1600, which in some embodiments may be integrated with the one of the planar substrates 1650. Other embodiments fully exclude or limit the functionality of the battery management system.

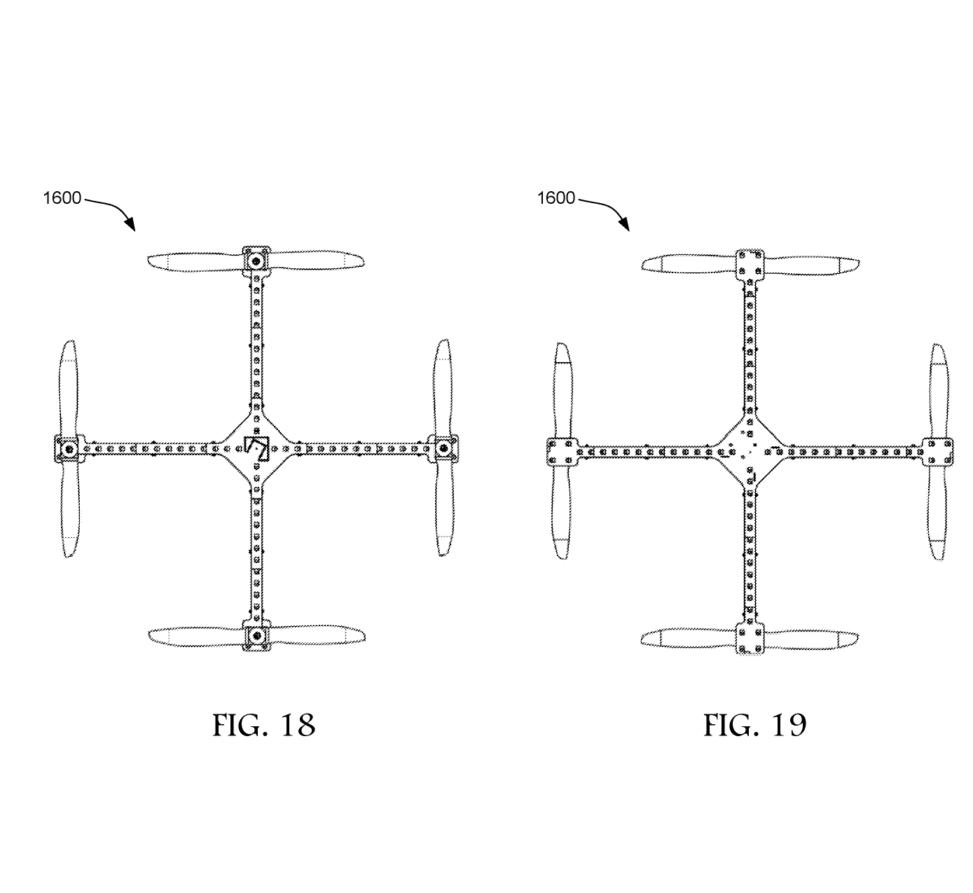

FIGS. 18 and 19 are top and bottom views of the aircraft 1600, showing the distribution of power planes and locations of various cell equipotentials. In the illustrated embodiment, each arm 1630 includes four cells 110 directly below the motor 1620 and 12 more cells 110 along the length of the arm 1630 for a total of 18 cells 110. These are grouped into three sets of six cells 110 each, where the cells 110 in each set share a common orientation. In FIGS. 18 and 19 each set of six cells 110 attaches to a section 170 so all six cells 110 are connected in parallel. These sets are, in turn, connected in series and to the motor 1620. It is also noted that these illustrations show that the planar substrates 1650 comprise the footprint of the quadcoptor and as such, all four arms 1630 are integral with the hub 1640. Alternatively, four battery modules 1000 can be connected to a hub 1640.

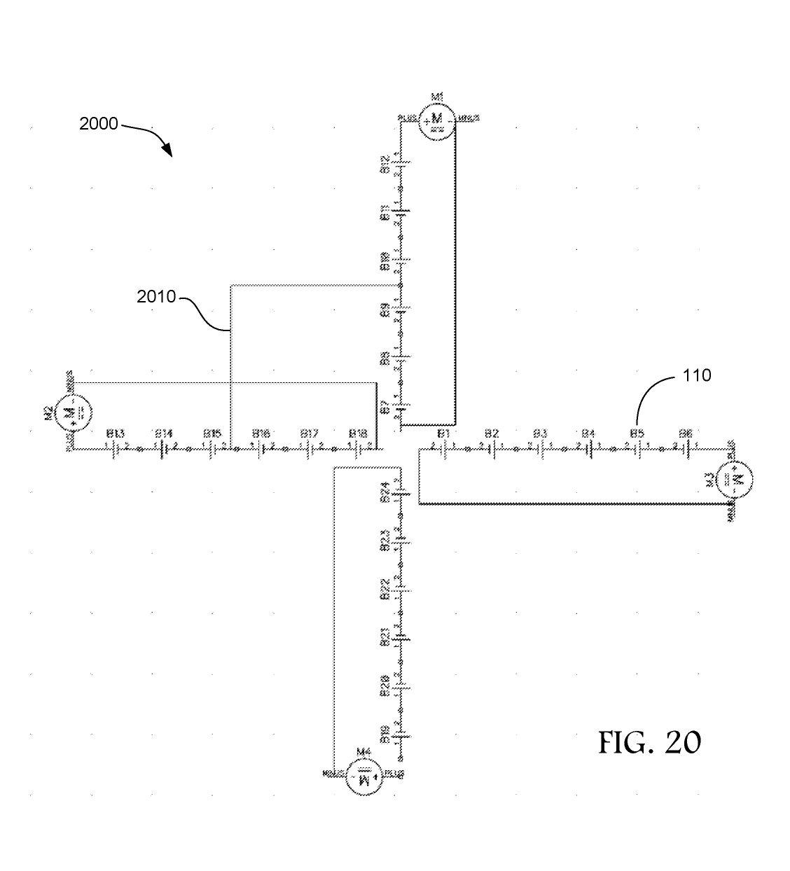

FIG. 20 provides a circuit schematic representation of an exemplary layout of cells 110 in a multirotor aircraft similar to aircraft 1600. While the circuit 2000 has four-fold symmetry, the same arrangement can be extended to other symmetries. Cells 110 are shown increasing in series count radially outwards. A common ground exists at the center (not shown). In FIG. 20, M represents a motor and inverter/speed controller assembly, the electrical load. The positive most terminal of each battery module is positioned radially outward, with the ground towards the aircraft's center. In this embodiment, cells 110 are connected in series, and preferably oriented with their longitudinal axes arranged coaxially and aligned with the axis of the structural member in question, such as an arm. Wires or traces connecting points of equal potential in different arms may be used to share charge between them for either slow balancing or transient current sharing. For clarity, only one balance net 2010 is shown for illustration.

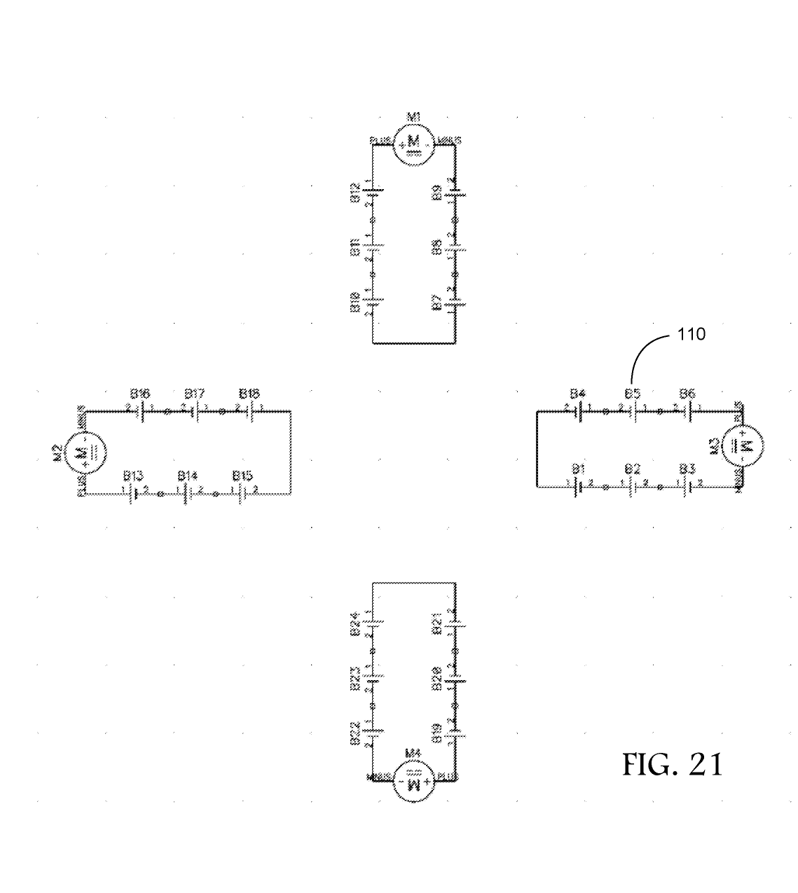

FIG. 21 provides a circuit schematic representation of another exemplary layout of cells 110 in a multirotor aircraft. Here, the cells 110 are electrically connected so as to form a “U” current path. Balancing nets and the common ground are not shown. The radial “U” path eliminates the waste mass of a return current bus as the most positive and negative potentials are co-located at the site of the electrical load.

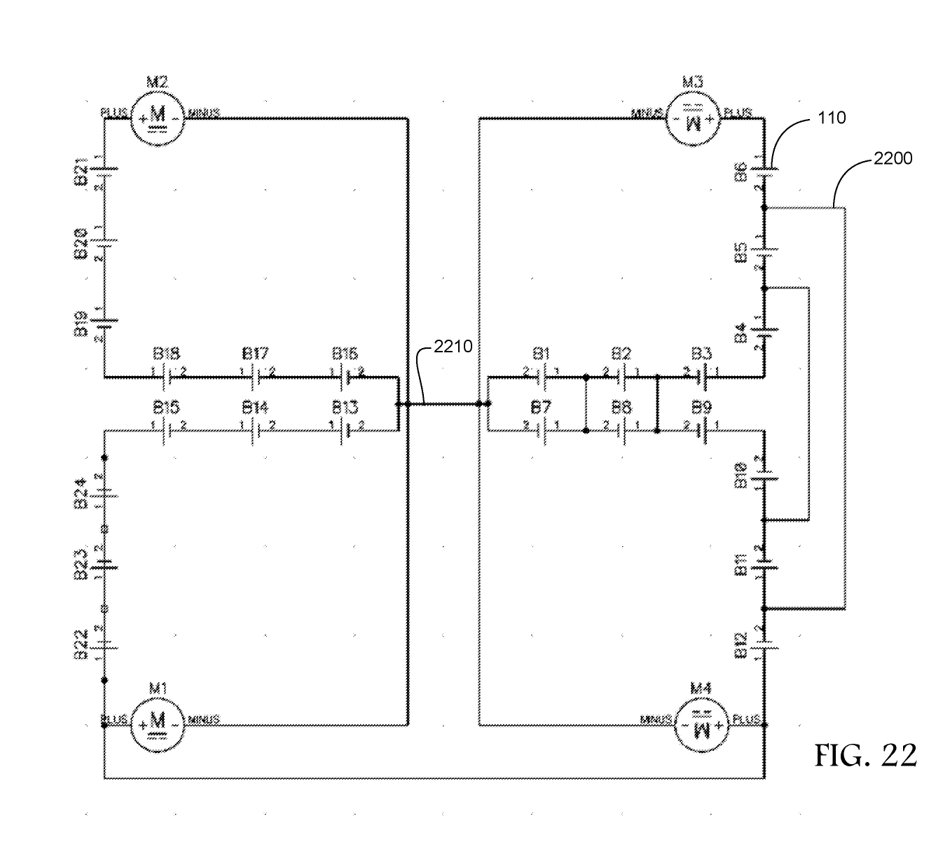

FIG. 22 provides a circuit schematic representation of yet another exemplary layout of cells 110 for a multirotor aircraft, in this instance, an H-figure multirotor (two arms which branch to become four). Cells 110 are first located together in the first set of arms, then split to half the parallel count in the branched arms, while, remaining electrically connected. In embodiments containing branched arms (such as H configurations), cells 110 of some potentials may be co-located while those of other potentials may be physically spread apart, but connected with balance conductors. Five balance nets 2200 are shown, as well as a common ground 2210.

Passive fuses or active battery management can be added between points of equal potential within battery modules and between battery modules to provide fault tolerance. FIG. 23 provides a circuit schematic representation of exemplary battery protection and fusing between arms of a multirotor aircraft, but could represent any two parallel circuits within or between battery modules. Here, low current fuses 2300 are used to connect points of equal but intermediate potential while battery protection field-effect transistors (FETs) 2310 can be used at the top potential.

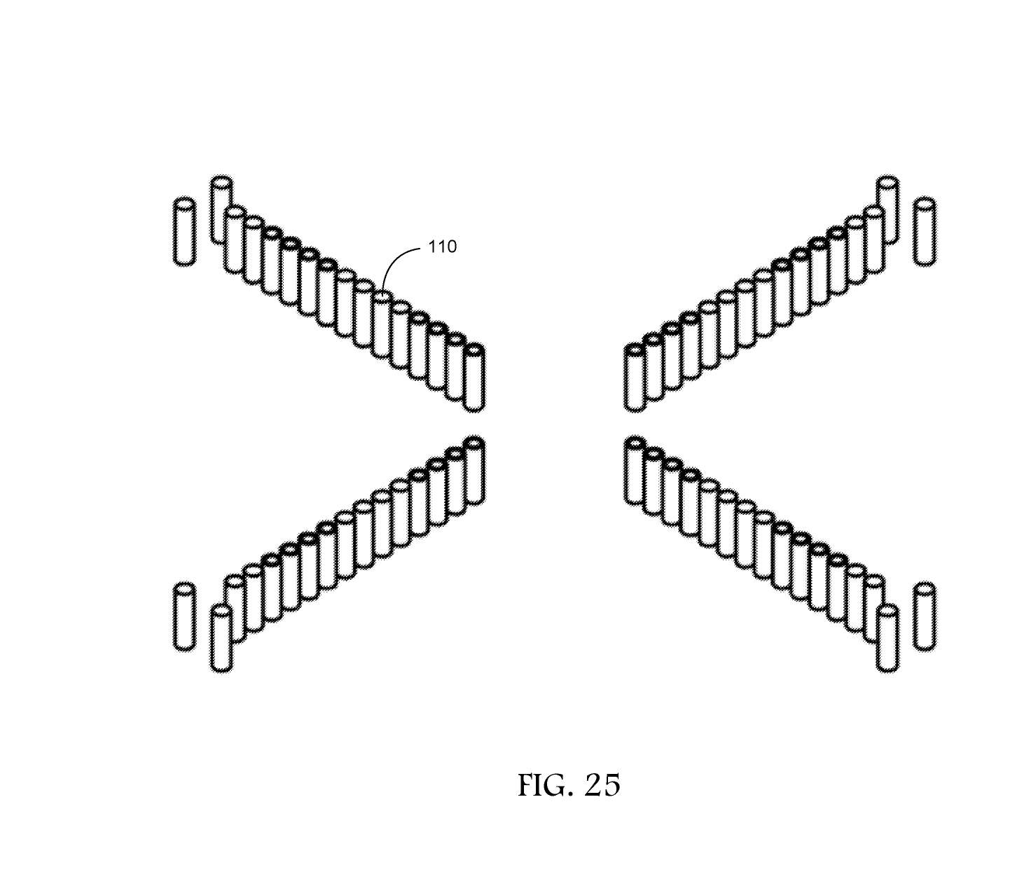

FIG. 24 shows an exemplary arrangement of cells 110 for a hexacopter comprising six arms. Cells 110 are shown alternating in orientation every parallel group of four cells 110 to enable series interconnects. FIG. 25 shows a four-armed embodiment of the example shown in FIG. 24. This arrangement is also similar to that provided in aircraft 1600, however, that arrangement had four cells 110 beneath each motor 1620 and 18 cells 110 per arm 1630 with sets of six parallel cells 110 alternating in orientation, whereas in FIG. 25 16 cells 110 are arranged in four sets of four parallel cells 110 alternating in orientation, with only two intended to be beneath each motor. It will be appreciated that for both illustrated cell arrangements, the longitudinal axes of the cells 110 can be either perpendicular or parallel to the planes of the planar substrates to which they are secured.

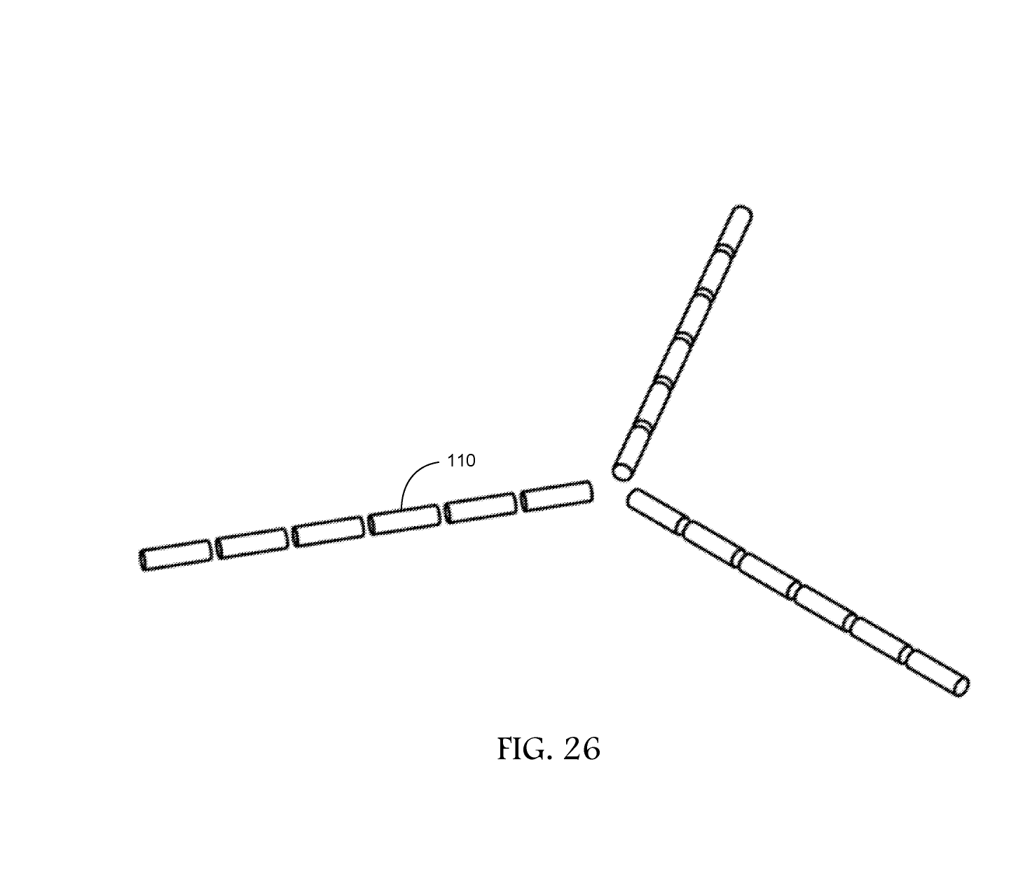

FIG. 26 shows an exemplary arrangement of cells 110 for a tricoptor or Y6-style hexacoptor, defined as having two rotors at the end of each arm, one above and one below. In this embodiment, and the previous ones directed to multirotor aircraft, each motor receives power from the cells of the respective arm, mostly eliminating current sharing, resulting in shorter current path lengths, lower resistive losses, and less metal mass devoted to current conduction. These embodiments also benefit aerodynamically by eliminating the protrusion caused by a large, centrally located battery system. Distributing the cells 110 rather than concentrating them together in a central battery system also improves fire tolerance.

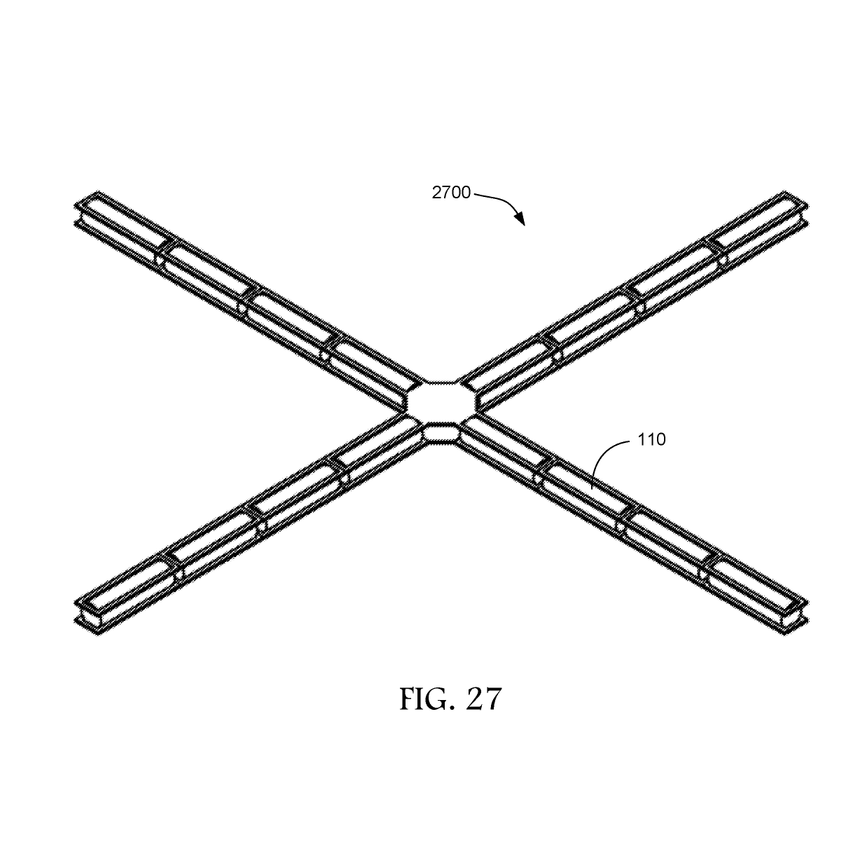

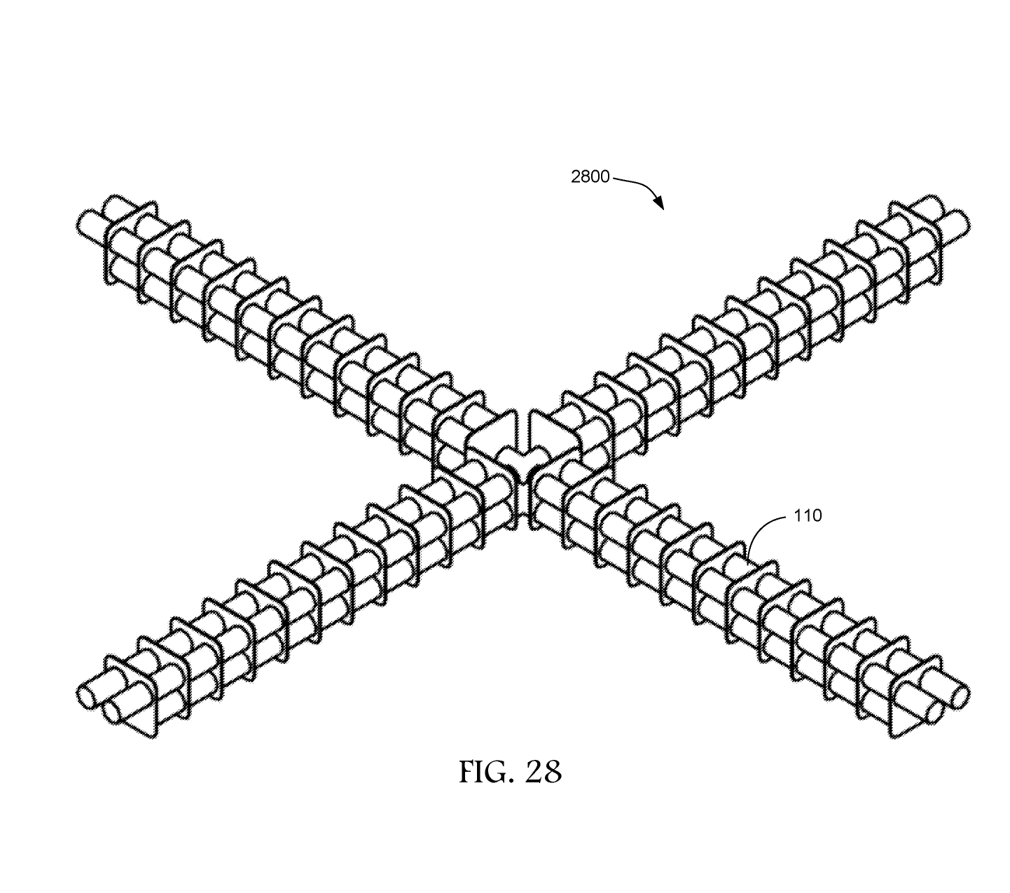

FIG. 27 shows a battery module 2700 in the form of a quadcoptor. It will be appreciated that the mass of this structure is almost entirely that of the cells 110. FIG. 28 shows a battery module 2800 also in the form of a quadcoptor. Again, the mass of this structure is almost entirely that of the cells 110. A standard 22V assembly (six cells 110 in series) corresponds to an arm length of 390 millimeters, which is similar to the frame arm length of a DJI S1000 (389 mm).

In all of the various arrangements noted herein a PCB can be replaced with a flexible circuit board made via cutting or etching processes on a plastic stiffener. See US Patent Application pre-Grant Publication 2014/0212695 A1 by Lane et al.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art. The use of the term “means” within a claim of this application is intended to invoke 112(f) only as to the limitation to which the term attaches and not to the whole claim, while the absence of the term “means” from any claim should be understood as excluding that claim from being interpreted under 112(f). As used in the claims of this application, “configured to” and “configured for” are not intended to invoke 112(f).

What is claimed is:

1. A battery module for use in an electric aircraft, the module comprising:
a first planar substrate;
a second planar substrate disposed essentially parallel to the first planar substrate; and
a plurality of electrochemical cells secured to and between the first and second planar substrates.

2. The battery module of claim 1 wherein the first and second planar substrates each define a plane and wherein the electrochemical cells are arranged with their longitudinal axes parallel to the planes of the planar substrates.

3. The battery module of claim 2 wherein the first planar substrate includes essentially rectangular slots and the electrochemical cells engage with the slots.

4. The battery module of claim 1 wherein the first and second planar substrates each define a plane and wherein the electrochemical cells are arranged with their longitudinal axes perpendicular to the planes of the planar substrates.

5. The battery module of claim 4 wherein the first planar substrate includes apertures and some of the plurality of electrochemical cells are disposed through the apertures.

6. The battery module of claim 1 wherein the first planar substrate comprises a metal layer having isolated sections defined therein by gaps in the metal layer, wherein the first planar substrate includes a number of terminals, each terminal configured for making an electrical connection to one of the plurality of electrochemical cells.

7. The battery module of claim 6 wherein the metal layer on the first planar substrate is disposed on a side of the first planar substrate facing away from the plurality of electrochemical cells, and a terminal of the number of terminals comprises a hole through the first planar substrate.

8. The battery module of claim 7 wherein the terminal further includes a bonding pad defined in the metal layer of the first printed circuit board and wherein the bonding pad is electrically connected to the metal layer of the first printed circuit board by a fuse.

9. The battery module of claim 7 wherein an electrochemical cell of the plurality of electrochemical cells is in electrical contact with the metal layer of the first planar substrate through the hole of the terminal of the first planar substrate.

10. The battery module of claim 9 wherein the electrochemical cell is in electrical contact with the metal layer through the hole by a metal ribbon disposed through the hole and electrically connected both to the electrochemical cell and to the metal layer.

11. The battery module of claim 1 wherein the first and second planar substrates have a non-rectangular footprint.

12. The battery module of claim 11 wherein the footprint comprises an airfoil rib.

13. The battery module of claim 11 wherein the footprint comprises a multirotor aircraft footprint.

14. The battery module of claim 1 wherein the electrochemical cells are secured to the first planar substrate with an adhesive that adheres each cell to the first planar substrate.

15. The battery module of claim 1 wherein the electrochemical cells of the plurality of electrochemical cells are secured between the first and second planar substrates by tensioners attached to both the first and second planar substrates, where the tensioners span between the two planar substrates to provide a compressive load to the electrochemical cells.

16. The battery module of claim 1 further comprising a discrete electrical component disposed on the first planar substrate.

17. The battery module of claim 1 further including a fan configured to move air between the plurality of electrochemical cells.

18. The battery module of claim 1 wherein the first and second planar substrates comprise printed circuit boards.

19. The battery module of claim 1 wherein the electrochemical cells comprise the 18650 format.

20. The battery module of claim 1 wherein the electrochemical cells are secured to the planar substrates with an adhesive, solder, or a weld.

21. A battery module for use in an electric aircraft, the module consisting essentially of:
a first planar substrate;
a second planar substrate disposed essentially parallel to the first planar substrate; and
a plurality of electrochemical cells secured to and between the first and second planar substrates.

22. A battery module for use in an electric aircraft, the module comprising:
a number of essentially parallel planar substrates; and
a layer of electrochemical cells secured to and between every two adjacent planar substrates of the number of planar substrates, the planar substrates including metal layers that provide electrical connections between the electrochemical cells.

23. The battery module of claim 22 wherein the longitudinal axes of the electrochemical cells in adjacent layers are parallel but not coaxial.

24. The battery module of claim 22 wherein the longitudinal axes of the electrochemical cells within each layer are parallel to the planes defined by the planar substrates secured on either side thereof, and wherein the electrochemical cells of each layer comprise a plurality of rows thereof, wherein the electrochemical cells in adjacent rows are staggered relative to one another.

25. The battery module of claim 24 wherein the electrochemical cells in adjacent layers are staggered relative to one another.

26. The battery module of claim 22 wherein the planar substrates include essentially rectangular slots and the electrochemical cells engage with the slots.

27. The battery module of claim 22 wherein the planar substrates include apertures sized to receive the electrochemical cells, and wherein the electrochemical cells extend through the apertures.

28. The battery module of claim 27 wherein the electrochemical cells are cylindrical and the negative polarity of each electrochemical cell is connected to a metal layer of a planar substrate of the plurality of planar substrates by an electrical connection made to the metal layer and to the cylindrical side of each electrochemical cell.

29. The battery module of claim 22 wherein the electrochemical cells of adjacent layers are electrically connected in series across the planar substrate, of the plurality of planar substrates, disposed therebetween.
